(19) United States
(12) Patent Application Publication
(10) Pub. No.: US 2015/0231770 A1
(43) Pub. Date: Aug. 20, 2015

(54) ROTARY IMPACT TOOL

(71) Applicant: MAKITA CORPORATION, Anjo-shi (JP)

(72) Inventors: Takuya KUSAKAWA, Anjo-shi (JP); Goshi ISHIKAWA, Anjo-shi (JP); Toshihisa TAKADA, Anjo-shi (JP)

(21) Appl. No.: 14/625,311

(22) Filed: Feb. 18, 2015

(30) Foreign Application Priority Data
Feb. 18, 2014 (JP) 2014-028548

(51) Int. Cl. B25B 21/02

(52) U.S. Cl. CPC B25B 21/02

(57) ABSTRACT

There is provided a rotary impact tool that comprises: an impact mechanism, in which, when an external torque of a specified value or greater is applied to an anvil, a hammer impacts the anvil in a rotational direction; an impact detection unit configured to detect the impact; a fluctuation width detection unit configured to detect a fluctuation width of a physical quantity that fluctuates due to the impact; and a control unit configured to control driving of the motor according to the fluctuation width of the physical quantity when the impact is detected after a starting of the motor.

### CROSS-REFERENCE TO RELATED APPLICATIONS

This application claims the benefit of Japanese Patent Application No. 2014-028548 filed Feb. 18, 2014 in the Japan Patent Office, the disclosure of which is incorporated herein by reference.

### BACKGROUND

The present invention relates to a rotary impact tool that is configured to rotate by a rotation force of a motor, and to apply an impact force in a rotational direction when an external torque of a specified value or greater is applied.

A rotary impact tool of this type is provided with an impact mechanism having a hammer that rotates receiving a rotational force of a motor and an anvil that rotates receiving a rotational force of the hammer. When the motor rotates, the rotational force of the motor is transmitted from the hammer through the anvil to a tool element (for example, a driver bit or a socket bit) to thereby rotate the tool element.

When an external torque of a specified value or greater is applied to the anvil, the hammer leaves the anvil and rotates idly so that the hammer impacts the anvil in a rotational direction. Such impact occurs intermittently while the external torque of the specified value or greater is being applied to the anvil. The resulting impact force allows secure tightening and easy loosening of a rotation object, such as a screw or a bolt.

As a method for controlling a motor in such a rotary impact tool, various methods have been proposed, in which a start of application of an impact is detected, and control details are changed between before and after the detection. Also, various methods have been proposed as a method for detecting a start (i.e., an occurrence) of an impact. Japanese Unexamined Patent Application Publication No. 2013-111729 includes the description of a control method in which occurrence or non-occurrence of an impact is detected based on a fluctuation width of a rotation number of the motor, and the rotation number is reduced when a start (i.e., an occurrence) of an impact is detected.

### SUMMARY

It is desirable for a rotary impact tool to control a motor appropriately also during an operation after detecting a start of application of an impact, i.e., while applying an impact intermittently, in accordance with the state of impacting.

Control of a motor is usually performed based on detected values of various physical quantities in the motor or the tool, such as a rotation number of the motor, a current flowing in the motor, and a voltage applied to the motor. However, these physical quantities during impacting have larger fluctuations than those while application of an impact is not performed. Also, regardless of whether or not application of an impact is performed, these physical quantities may be changed due to various factors, such as a power supply voltage of the tool and/or an ambient temperature. Accordingly, it is not easy to control the motor during impacting by using the values themselves of the various physical quantities in the tool.

It is desirable for a rotary impact tool to control a motor appropriately during impacting, in accordance with a state of the impacting, and thus to enable an operation using an impact force to be performed properly.

A rotary impact tool in one aspect of the present invention comprises a motor; an impact mechanism; an impact detection unit; a fluctuation width detection unit; and a control unit.

The impact mechanism comprises: a hammer that rotates by a rotational force of the motor; an anvil that rotates by receiving a rotational force of the hammer; and an attachment portion to attach a tool element to the anvil. When an external torque of a specified value or greater is applied to the anvil, the hammer leaves the anvil and rotates idly so that the hammer impacts the anvil in a rotational direction.

The impact detection unit detects an impact to the anvil by the hammer. The fluctuation width detection unit detects, when an impact is detected by the impact detection unit, a fluctuation width of a physical quantity that fluctuates due to the impact. The control unit controls driving of the motor. When an impact is detected by the impact detection unit after a start of the driving of the motor, the control unit controls the driving of the motor according to the fluctuation width detected by the fluctuation width detection unit.

In the rotary impact tool, when application of an impact starts after the start of the driving of the motor, fluctuation of a physical quantity occurs due to the impact during impacting. A fluctuation width of the physical quantity that fluctuates due to the impact directly or indirectly indicates the state of impacting. A value itself of the physical quantity depends also on various factors, such as a power supply voltage of the motor and an ambient temperature, and thus is not suitable to be used for controlling, whereas a fluctuation width of the physical quantity depends less on the various factors and is less affected thereby.

Accordingly, when an impact is detected, the control unit controls the driving of the motor according to the fluctuation width of the physical quantity that fluctuates due to the impact. By using the fluctuation width, various controls depending on the state of impacting can be effectively performed.

According to the rotary impact tool in one aspect of the present invention, therefore, it is possible to appropriately control the motor depending on the state of impacting by using the fluctuation width of the physical quantity that fluctuates due to the impact to control the motor during the impacting. Thus, an operator can appropriately perform an operation using an impact force.

The physical quantity to be detected may be any physical quantity that fluctuates due to an impact. For example, a physical quantity that fluctuates at the same cycle as that of occurrence of an impact may be used. The fluctuation of a physical quantity that occurs in synchronization with the cycle of application of an impact is likely to better reflect the state of impacting. Thus, by using the fluctuation of such physical quantity, it is possible to perform the driving control of the motor during impacting accurately in consideration of the state of impacting.

A physical quantity whose fluctuation occurs in synchronization with the cycle of application of an impact may be, for example, at least one of a rotation speed of the motor or a current flowing in the motor. Each time application of an impact is performed, the rotation speed and the current of the motor periodically fluctuate at the same cycle as the cycle of application of an impact. Also, the rotation speed and the current are parameters that are commonly used to control a motor. Regardless of occurrence or non-occurrence of an impact, a motor is usually controlled by using the rotation speed and/or the current.

By using the rotation speed and/or the current usually used in motor control also during impacting (more specifically, by using the fluctuation width of the rotation speed and/or the current), it is possible to perform the driving control of the motor during impacting accurately and efficiently.

One specific control method using the fluctuation width of a physical quantity may be a driving force limiting control. Specifically, the control unit may perform a driving force limiting control to reduce the rotation number of the motor and continue the driving of the motor or to stop the driving of the motor when the fluctuation width detected by the fluctuation width detection unit is equal to or greater than a fluctuation width threshold value.

While impacting is performed in the rotary impact tool, if the fluctuation width of the physical quantity exceeds a fluctuation width expected within a range of normal use, the rotary impact tool might not be used in a normally expected state of use. If use of (and thus impacting by) the rotary impact tool continues in such state of use, some abnormality or defect might occur in the rotary impact tool.

The rotary impact tool can be protected from occurrence of abnormality, defect, etc. by setting a fluctuation width threshold value and performing the driving force limiting control when the fluctuation width of the physical quantity during impacting is equal to or greater than the fluctuation width threshold value.

The rotary impact tool may, for example, specifically comprise an operation unit to receive an operation input to drive the motor, and may be configured such that the control unit sets a speed command value of the motor according an operation amount of the operation unit, and drives the motor based on the set speed command value.

In the rotary impact tool with such configuration, the control unit may be configured to perform the driving force limiting control as follows: The control unit performs, as the driving force limiting control, a control to reduce the speed command value to less than a value according the operation amount or set the speed command value to a value corresponding to stopping of the motor when the fluctuation width detected by the fluctuation width detection unit is equal to or greater than the fluctuation width threshold value.

As described above, the driving force limiting control may be easily achieved by performing the driving force limiting control by changing the setting of the speed command value from the value according the operation amount.

The control unit may set the timing of executing the driving force limiting control as follows: When an impact is detected by the impact detection unit, the control unit determines, each time a fluctuation width is detected by the fluctuation width detection unit, whether the fluctuation width is equal to or greater than the fluctuation width threshold value, and cumulatively adds the number of determinations that the fluctuation width is equal to or greater than the fluctuation width threshold value. When the number of cumulative additions is equal to or greater than a specified number, the control unit executes the driving force limiting control.

That is, it may be configured such that the driving force limiting control is not executed immediately when the fluctuation width is equal to or greater than the fluctuation width threshold value, but executed when the number of determinations that the fluctuation width is equal to or greater than the fluctuation width threshold value is cumulatively added to a number equal to or greater than the specified number. With such configuration, it is possible to accurately detect the fluctuation width that occurs due to the impact, and it is possible to accurately determine whether or not to execute the driving force limiting control.

In a case where the rotary impact tool comprises a rotational direction setting unit to set a rotational direction of the motor, the control unit may be configured not to execute the driving force limiting control depending on the rotational direction. Specifically, the control unit may be configured not to perform the driving force limiting control regardless of the fluctuation width when the rotational direction set by the rotational direction setting unit is a direction of removing a rotation object from a workpiece with the tool element.

Generally, in the case of removing a rotation object from a workpiece, driving of the motor without reducing the rotational force after a start of application of an impact is less likely to cause a problem as compared with the case of tightening the rotation object into the workpiece. Also, by continuing application of an impact without reducing the rotational force even after the start of application of an impact, the rotation object can be removed rapidly from the workpiece. Accordingly, while an operation to remove the rotation object from the workpiece is performed, reduction in work efficiency can be inhibited by not performing the driving force limiting control.

Another specific control method using the fluctuation width of a physical quantity may be the following control method. Specifically, the control unit may be configured to calculate a total impact rotation angle, which is a rotation angle of the tool element after the start of application of an impact, based on the fluctuation width detected by the fluctuation width detection unit, and to control the motor according to the calculated total impact rotation angle.

While impacting is performed in the rotary impact tool, a rotation amount (rotation angle) of the tool element by each impact is reflected to the fluctuation width of the physical quantity caused by the impact. For example, as the rotation angle per impact is larger, the fluctuation width of the physical quantity is smaller; as the rotation angle per impact is smaller, the fluctuation width of the physical quantity is usually larger. Accordingly, it is possible to estimate the rotation angle of the tool element per impact based on the fluctuation width of the physical quantity.

By calculating the rotation angle (total impact rotation angle) of the tool element from the start of application of an impact based on the fluctuation width of the physical quantity, and controlling the motor according to the total impact rotation angle, appropriate motor control according to the total impact rotation angle after the start of application of an impact can be achieved.

A specific example of motor control according to the total impact rotation angle may be a driving force limiting control. Specifically, the control unit may perform a driving force limiting control to reduce the rotation number of the motor and continue the driving of the motor or to stop the driving of the motor when the calculated total impact rotation angle is equal to or greater than a specified rotation angle. By performing the above driving force limiting control when the total impact rotation angle is equal to or greater than the specified rotation angle, an operation using an impact force can be performed without excess or deficiency.

In a case where the rotary impact tool comprises an operation unit to receive an operation input to drive the motor, and the control unit drives the motor based on the speed command value according to an operation amount of the operation unit, the control unit may be configured to perform the driving force limiting control in the following manner. Specifically, the control unit may perform, as the driving force limiting control, a control to reduce the speed command value to less than a value according the operation amount or setting the speed command value to a value corresponding to stopping of the motor when the calculated total impact rotation angle is equal to or greater than a specified rotation angle. By performing the driving force limiting control by changing the setting of the speed command value from the value according the operation amount as described above, the driving force limiting control may be easily achieved.

The control unit may calculate the total impact rotation angle in the following manner. Specifically, the control unit may be configured to calculate the total impact rotation angle, when an impact is detected by the impact detection unit, by using, as a calculation target fluctuation width, at least one of a fluctuation width at the time of a change from a minimum value to a maximum value or a fluctuation width at the time of a change from a maximum value to a minimum value in a process of fluctuation of the physical quantity, and by cumulatively adding a unit impact rotation angle corresponding to the calculation target fluctuation width each time the calculation target fluctuation width is detected by the fluctuation width detection unit.

By setting respective unit impact rotation angles according to the fluctuation widths continuously or stepwisely, and cumulatively adding a unit impact rotation angle corresponding to the calculation target fluctuation width each time the calculation target fluctuation width is detected by the fluctuation width detection unit, the total impact rotation angle from the start of application of an impact can be calculated highly accurately.

A further specific control method using the fluctuation width of a physical quantity may be the following control method. Specifically, the control unit may be configured to compare the fluctuation width detected by the fluctuation width detection unit and a preset target fluctuation width, and to control the driving of the motor such that the fluctuation width will match the preset target fluctuation width.

Generally, in a rotary impact tool, application of an impact might not be performed at an appropriate timing depending on the rotation speed of the motor, the material of a workpiece as an operation target, or the like. The timing of application of an impact and the fluctuation width of the physical quantity correlate with each other; a fluctuation width when application of an impact is performed at an appropriate timing and a fluctuation width when application of an impact is not performed at an appropriate timing are mostly different.

Accordingly, by setting the target fluctuation width appropriately (for example, setting to a value within a range of expected fluctuation width when application of an impact is performed at an appropriate timing), and controlling the driving of the motor such that an actual fluctuation width will match the target fluctuation width, it is possible to perform application of an impact at an appropriate timing.

In a case where the rotary impact tool comprises an operation unit to receive an operation input to drive the motor, and the control unit drives the motor based on the speed command value according to the operation amount of the operation unit, the control unit may perform the motor control based on the target fluctuation width in the following manner. Specifically, the control unit may be configured to correct the speed command value according the operation amount, when an impact is detected by the impact detection unit, based on a difference between the fluctuation width detected by the fluctuation width detection unit and the target fluctuation width, and to drive the motor according to the corrected speed command value. By correcting the speed command value, which is set according the operation amount, based on the difference between the actual fluctuation width and the target fluctuation width (i.e., correction to make the difference “0”) as described above, appropriate timing of application of an impact can be easily achieved.

### BRIEF DESCRIPTION OF THE DRAWINGS

Hereinafter, some embodiments of the present invention will be described with reference to the accompanying drawings, in which:

FIG. 1 is a vertical sectional view of a rechargeable impact driver according to the embodiments;

FIG. 2 is a block diagram showing an electrical configuration of the rechargeable impact driver;

FIG. 3 is an explanatory view illustrating states of fluctuation of a rotation number and a current of a motor while impacting is performed;

FIG. 4 is a flowchart showing a main process of a first embodiment;

FIG. 5 is a flowchart showing details of a motor control process in S60 in the main process of FIG. 4;

FIG. 6 is a flowchart showing details of a workpiece discrimination process in S120 in the motor control process of FIG. 5;

FIG. 7 is a flowchart showing details of a speed command value setting process in S130 in the motor control process of FIG. 5;

FIGS. 8A-8B are explanatory view showing respective tables used in a second embodiment, in which FIG. 8A shows a weighting table, and FIG. 8B shows a threshold value table;

FIG. 9 is a flowchart showing details of a motor control process of the second embodiment;

FIG. 10 is a flowchart showing details of an impact rotation angle setting process in S410 in the motor control process of FIG. 9;

FIG. 11 is a flowchart showing details of an impact rotation angle discrimination process in S430 in the motor control process of FIG. 9;

FIG. 12 is a flowchart showing details of a motor control process of a third embodiment;

FIG. 13 is a flowchart showing details of a new value setting process in S830 in the motor control process of FIG. 12; and

FIG. 14 is a flowchart showing another embodiment of the new value setting process in S830 in the motor control process of FIG. 12.

### DETAILED DESCRIPTION OF THE PREFERRED EMBODIMENTS

### First Embodiment

Hereinafter, a description will be given of a rechargeable impact driver 1 as an example of a rotary impact tool according to the present invention.

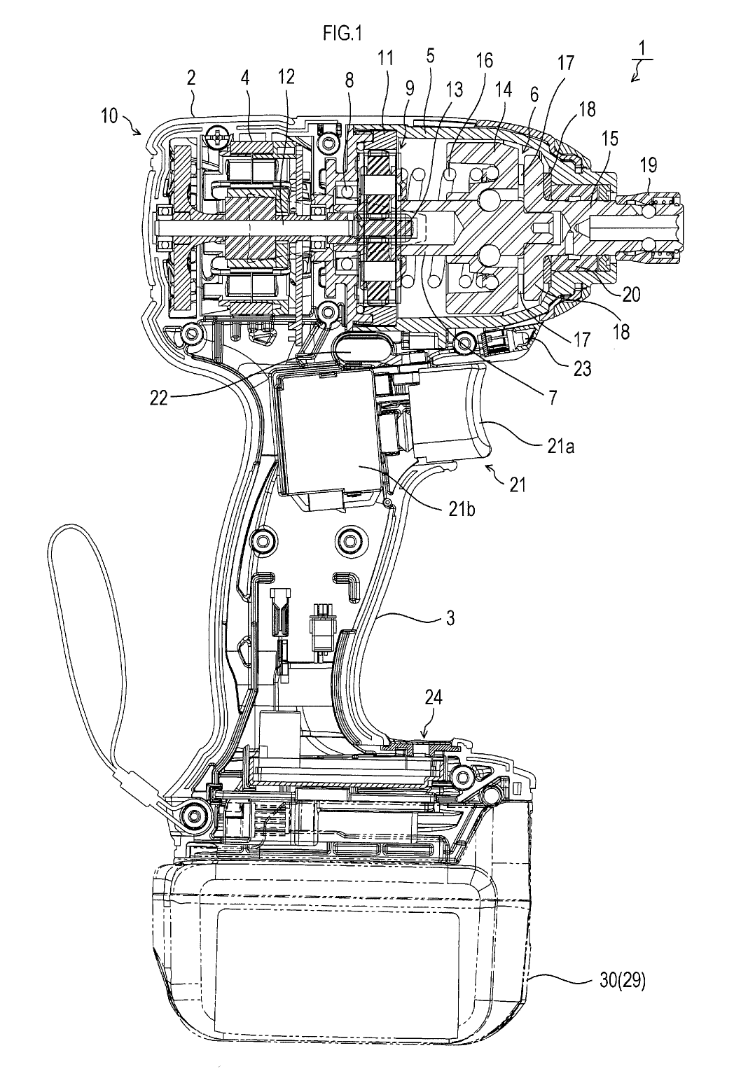

As shown in FIG. 1, the rechargeable impact driver 1 of the first embodiment comprises a tool body 10 and a battery pack 30 to supply power to the tool body 10. The tool body 10 comprises a housing 2, in which a motor 4, an impact mechanism 6, and other components are housed, and a grip portion 3 configured to protrude from a lower portion (on a lower side of FIG. 1) of the housing 2.

The motor 4 is housed in a rear portion of the housing 2 (on a left side of FIG. 1). The motor 4 is a three-phase brushless motor having armature windings of respective phases U, V, and W in the first embodiment. In the housing 2, a bell-shaped hammer case 5 is assembled forward of the motor 4 (on a right side of FIG. 1). The impact mechanism 6 is housed in the hammer case 5.

A spindle 7 is housed in the hammer case 5 coaxially with the motor 4 and the like. A hollow part is provided in a rear end portion of the spindle 7. A ball bearing 8 that is provided in a rear end portion of the hammer case 5 pivotally supports an outer periphery of the rear end portion of the spindle 7. In an area forward of the ball bearing 8, a planetary gear mechanism 9 that includes two planetary gears pivotally supported in a symmetrical manner with respect to a rotation axis is engaged with an internal gear 11 provided to an inner surface of the rear end portion of the hammer case 5. The planetary gear mechanism 9 engages with a pinion 13 provided at a front end of an output shaft 12 of the motor 4.

The impact mechanism 6 comprises the spindle 7, a hammer 14 externally mounted to the spindle 7, an anvil 15 pivotally supported forwardly of the hammer 14, and a coil spring 16 that forwardly biases the hammer 14.

The hammer 14 is coupled to the spindle 7 so as to be integrally rotatable with the spindle 7 and axially movable. The hammer 14 is biased forwardly (toward the anvil 15) by the coil spring 16. A front end of the spindle 7 is inserted with a play (or clearance) into a rear end portion of the anvil 15. The spindle 7 is pivotally supported so as to be coaxially rotatable with the anvil 15.

The anvil 15 is rotatable around an axis by receiving a rotational force and an impact force by the hammer 14. Specifically, the anvil 15 is supported by a bearing 20 provided at a front end of the housing 2 so as to be rotatable around the axis and to be axially nondisplaceable.

A sleeve 19, to which various tool elements (not shown), such as a driver bit or a socket bit, are to be mounted, is provided at a front end of the anvil 15. These tool elements are used to rotate various screws, bolts, nuts, etc. as rotation objects to thereby tighten the various screws, bolts, nuts, etc. to a workpiece. The output shaft 12 of the motor 4, the spindle 7, the hammer 14, the anvil 15, and the sleeve 19 are coaxially arranged.

Two impact projections 17, 17 to apply impact force to the anvil 15 are projectingly provided on a front end surface of the hammer 14 at a circumferential interval of 180° therebetween. Two impact arms 18, 18 are provided at the rear end of the anvil 15 at a circumferential interval of 180° therebetween. The two impact arms 18, 18 are configured to be abuttable by the respective impact projections 17, 17 of the hammer 14.

Since the hammer 14 is biased toward the front end side of the spindle 7 by a biasing force of the coil spring 16 (and is held so as to be positioned at the front end side of the spindle 7), the two impact projections 17, 17 of the hammer 14 are brought into abutment with the respective two impact arms 18, 18 of the anvil 15.

When the spindle 7 is rotated by a rotational force of the motor 4 through the planetary gear mechanism 9, the hammer 14 rotates together with the spindle 7, and a rotational force of the hammer 14 is transmitted to the anvil 15 through the two impact projections 17, 17 and the two impact arms 18, 18. This causes the tool element attached to the front end of the anvil 15 to rotate, to thereby allow tightening of the rotation object, such as a screw or a bolt.

In a case where the tool element rotates in a forward direction (in a clockwise direction when seen frontward from a rear side of the tool body 10 in the first embodiment), the rotation object is tightened to the workpiece. In a case where the tool element rotates in a reverse direction (in a counter-clockwise direction when seen frontward from the rear side of the tool body 10 in the first embodiment), tightening of the rotation object to the workpiece is loosened.

In the description hereinafter, a rotational direction of the motor 4 when rotating the tool element in the forward direction is defined as a forward direction, whereas a rotational direction of the motor 4 when rotating the tool element in the reverse direction is defined as a reverse direction. In addition, rotation of the motor 4 or the tool element in the forward direction is also referred to as normal rotation, whereas rotation of the motor 4 or the tool element in the reverse direction is also referred to as reverse rotation.

At a stage where tightening of the rotation object to the workpiece proceeds by the rotation of the tool element, or at an initial stage of loosening thereof, the rotational force (torque) of the hammer 14 against the anvil 15 reaches or exceeds a specified value if an external torque of a specified value or greater is applied to the anvil 15.

This causes rearward displacement of the hammer 14 against the biasing force of the coil spring 16, and the two impact projections 17, 17 of the hammer 14 ride over the two impact arms 18, 18 of the anvil 15. In this situation, the two impact projections 17, 17 of the hammer 14 once leave the two impact arms 18, 18 of the anvil 15 and rotate idly.

When the two impact projections 17, 17 of the hammer 14 ride over the two impact arms 18, 18 of the anvil 15, the hammer 14 is displaced forward again by the biasing force of the coil spring 16, while rotating together with the spindle 7, and then the two impact projections 17, 17 of the hammer 14 impact the two impact arms 18, 18 of the anvil 15 in the rotational direction.

Accordingly, each time an external torque of a specified value or greater is applied to the anvil 15, application of an impact to the anvil 15 by the hammer 14 is repeatedly (intermittently) performed. As a result of intermittent application of the impact force of the hammer 14 to the anvil 15, it is possible to tighten the rotation object to the workpiece at a high torque during rotation in the forward direction, and it is possible to easily loosen the rotation object from the workpiece during rotation in the reverse direction.

The grip portion 3 is a portion to be gripped by an operator who uses the rechargeable impact driver 1. A trigger switch 21 is provided above the grip portion 3. The trigger switch 21 comprises a trigger 21a and a switch body 21b. The trigger 21a is pulled by an operator. The switch body 21b is configured to be turned on/off by the pulling operation of the trigger 21a, and to have a resistance value that is variable according to an operated amount (a pulled amount) of the trigger 21a.

Above the trigger switch 21 (at a lower end of the housing 2), there is provided a forward/reverse changeover switch 22 to change the rotational direction of the motor 4 to one of the forward direction and the reverse direction. At a lower front of the housing 2, there is provided a lighting LED 23 that emits light and illuminates the front of the rechargeable impact driver 1 with the light when the trigger 21a is pulled.

At a lower front of the grip portion 3, there is provided an operation panel 24 that is capable of receiving a setting input by an operator and indicating, for example, a setting state and an operating state of the rechargeable impact driver 1.

The battery pack 30 that houses a battery 29 is attached to the lower end of the grip portion 3 in a detachable manner. By sliding the battery pack 30 from a front toward a rear of the lower end of the grip portion 3, the battery pack 30 is attached. The battery 29 housed in the battery pack 30 is a repeatedly rechargeable secondary battery, such as a lithium-ion secondary battery, in the first embodiment.

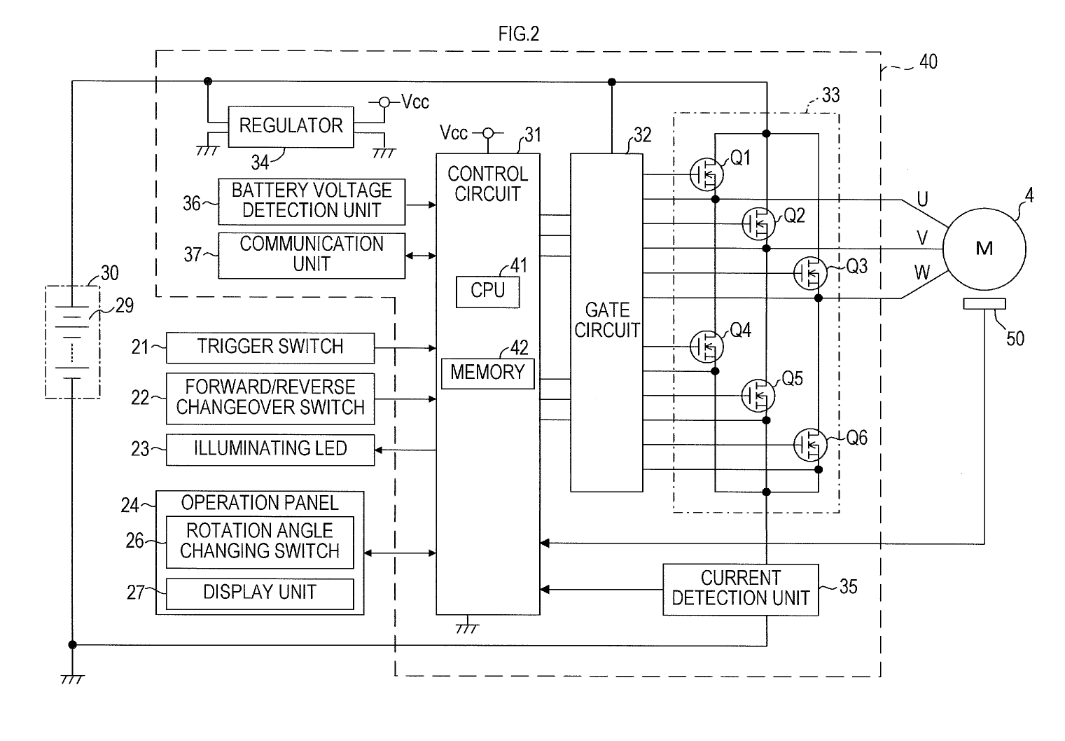

Although not shown in FIG. 1, a motor drive device 40 (see FIG. 2) to rotate the motor 4 by the power from the battery pack 30 is provided in the grip portion 3. Although not shown in FIG. 1, a Hall IC 50 (see FIG. 2) to detect a rotational position of the motor 4 is provided in the motor 4.

A rotary impact tool may be, for example, one that is designed and manufactured mainly for tightening a wood screw into a wooden workpiece (hereinafter, also referred to as a “specialized tool for wood screw”), or one that is capable of tightening to a metal workpiece a bolt, a nut, a screw, etc. corresponding to the metal workpiece (hereinafter, also referred to as a “specialized tool for machine screw”).

The rechargeable impact driver 1 of the first embodiment is a specialized tool for wood screw by way of example. However, it is possible to use a socket bit as the tool element, and thus it is possible to tighten a bolt or nut by using the socket bit.

Next, a description will be given of the motor drive device 40 provided inside the rechargeable impact driver 1 in order to rotate and control the motor 4 with reference to FIG. 2. In addition to the motor drive device 40, other components to be electrically connected to the motor drive device 40 are shown in FIG. 2. FIG. 2 shows a state where the battery pack 30 is attached to the tool body 10 (see FIG. 1) and thereby the battery 29 is electrically connected to the motor drive device 40.

As shown in FIG. 2, the motor drive device 40 comprises a control circuit 31, a gate circuit 32, a motor drive circuit 33, a regulator 34, a current detection unit 35, a battery voltage detection unit 36, and a communication unit 37.

The motor drive circuit 33 is a circuit to receive power supply of a specified direct current (DC) voltage (for example, 14.4 V) from the battery 29 and to supply currents to the windings of the respective phases of the motor 4. The motor drive circuit 33 comprises a three-phase full-bridge circuit that includes six switching elements Q1 to Q6 in the first embodiment. Each of the switching elements Q1 to Q6 is a MOSFET in the first embodiment.

In the motor drive circuit 33, three switching elements Q1 to Q3 are provided, as so-called high-side switches, between the respective terminals U, V, and W of the motor 4 and a power supply line connected to the positive side of the battery 29. The remaining three switching elements Q4 to Q6 are provided, as so-called low-side switches, between the respective terminals U, V, and W of the motor 4 and a ground line connected to the negative side of the battery 29.

The gate circuit 32 turns on/off the switching elements Q1 to Q6 in the motor drive circuit 33 according to drive signals outputted from the control circuit 31. The turning on/off of the switching elements Q1 to Q6 by the gate circuit 32 causes currents to flow in the windings of the respective phases of the motor 4, and thereby the motor 4 rotates.

In the first embodiment, the control circuit 31, which is configured as a so-called one-chip microcomputer by way of example, comprises an input/output (I/O) port, an AD converter, and a timer (these are not shown in the figure) in addition to a CPU 41 and a memory 42. The memory 42 may include a ROM, a RAM, and a rewritable non-volatile memory device (such as a flash ROM and an EEPROM). The CPU 41 executes various processes in accordance with various programs stored in the memory 42.

The trigger switch 21 (specifically the switch body 21b), the forward/reverse changeover switch 22, the lighting LED 23, and the operation panel 24, as described above, are connected to the control circuit 31. Also, the gate circuit 32, the current detection unit 35, the battery voltage detection unit 36, the communication unit 37, and the Hall IC 50 are connected to the control circuit 31.

The Hall IC 50 is a well-known rotation sensor. Specifically, the Hall IC 50 includes a Hall element, and is configured to output a pulse signal each time a rotational position of a rotor of the motor 4 reaches a specified rotational position (i.e., each time the motor 4 rotates by a specified amount). The control circuit 31 is capable of computing the rotational position and the rotation number of the motor 4 based on a pulse signal inputted from the Hall IC 50.

When the trigger 21a is pulled by a minute amount, a trigger-on signal indicating that the trigger switch 21 has been turned on (i.e., the trigger 21a has been pulled) is outputted from the switch body 21b forming the trigger switch 21. The trigger-on signal is inputted to the control circuit 31. When the trigger-on signal is inputted to the control circuit 31, the CPU 41 determines that the trigger switch 21 has been turned on.

While the trigger switch 21 is on, an operation signal indicating a voltage value according to a pulled amount of the trigger 21a is outputted from the switch body 21b in addition to the trigger-on signal. The operation signal is inputted to the control circuit 31. The CPU 41 controls the motor 4 such that the motor 4 rotates at a rotation number according to the pulled amount of the trigger 21a indicated by the inputted operation signal.

The CPU 41 calculates a speed command value according to the pulled amount of the trigger 21a based on the operation signal inputted from the trigger switch 21. Then, the CPU 41 outputs a drive signal according to the calculated speed command value to the gate circuit 32, to thereby cause the motor 4 to rotate at a rotation number according to the speed command value (i.e., a rotation number according to the pulled amount of the trigger 21a). The rotation number means a rotation number per unit time, and thus is the same as a rotation speed.

There may be various options for specifically what should be calculated as the speed command value. In the first embodiment, the CPU 41 drives the motor 4 by duty-driving of the switching elements Q1 to Q6. The drive signal outputted from the control circuit 31 to the gate circuit 32 is a signal indicating a duty ratio (hereinafter also referred to as the “duty signal”).

In the first embodiment, the CPU 41 calculates, as the speed command value, a duty ratio to rotate the motor 4 at the rotation number according to the pulled amount of the trigger 21a. As the pulled amount of the trigger 21a is greater, the duty ratio calculated as the speed command value becomes greater.

In the first embodiment, in a case where the trigger 21a is pulled while the motor 4 is stopped, the duty ratio is not immediately set to a duty ratio according to the pulled amount, but is increased to the duty ratio according to the pulled amount continuously or stepwisely during a certain time period. That is, a function to gradually increase the duty ratio after starting (i.e., a so-called soft start function) is provided.

The control of the motor 4 by the CPU 41 based on the pulled amount of the trigger 21a is basically an open control. Specifically, a speed command value (a duty ratio) according to the pulled amount of the trigger 21a is set and a drive signal (a duty signal) according to the speed command value is outputted, whereas feedback of an actual rotation number of the motor 4 corresponding to the drive signal and correction of the drive signal based thereon is not performed.

However, the open control of the motor 4 is only an example, and feedback control of the motor 4, for example, may be performed as follows. Specifically, a rotation number according to the pulled amount of the trigger 21a is set as the speed command value, and a drive signal indicating a duty ratio according to the set rotation number is outputted to the gate circuit 32. Then, feedback of the actual rotation number of the motor 4 is performed and correction of the drive signal (i.e., correction of the duty ratio) is made such that the actual rotation number is equal to the set rotation number (speed feedback control may be performed).

The actual rotation number may be computed based on the pulse signal inputted from the Hall IC 50 as described above. A physical quantity for feedback may be other than the rotation number.

Although open control or feedback control of the motor 4 may be appropriately selected, the description will continue based on the premise of open control unless otherwise specified in the first embodiment.

The CPU 41 rotates the motor 4 in a rotational direction set by the forward/reverse changeover switch 22 based on a rotational direction setting signal inputted from the forward/reverse changeover switch 22. The CPU 41 also performs a control to light the lighting LED 23 while the trigger 21a is pulled. Further, the CPU 41 performs a control of the operation panel 24 as well as a control based on the operation details of the operation panel 24. The operation panel 24 comprises a rotation angle changing switch 26 and a display unit 27. An explanation of specific functions of the operation panel 24 will be given in a later-described second embodiment.

The regulator 34 is a power supply circuit that reduces a voltage of the battery 29 and generates a specified power supply voltage Vcc (for example, DC 5 V). The control circuit 31 operates with the power supply voltage Vcc generated by the regulator 34.

The current detection unit 35 is provided in a conduction path from the motor drive circuit 33 to the negative electrode of the battery 29 and outputs a signal (a current detection signal) indicating a current flowing in the motor 4. The current detection signal outputted from the current detection unit 35 is inputted to the control circuit 31. The CPU 41 detects the current flowing in the motor 4 based on the current detection signal inputted from the current detection unit 35.

The CPU 41 performs a specified averaging process of the current detected based on the current detection signal, and then performs various control processes in accordance with the current after the averaging process. However, the averaging process of the current is not mandatory. The CPU 41 may also perform an averaging process of the rotation number of the motor 4. However, the averaging process of the rotation number is not mandatory.

The battery voltage detection unit 36 detects the voltage of the battery 29 and outputs a voltage detection signal indicating the voltage value to the control circuit 31. The CPU 41 detects the voltage of the battery 29 (a battery voltage) based on the voltage detection signal from the battery voltage detection unit 36, and uses the value of the battery voltage for various control processes as necessary.

The communication unit 37 comprises a wireless communication module to perform wireless communication with an external apparatus (for example, a communication apparatus) other than the rechargeable impact driver 1. The CPU 41 is capable of performing wireless communication with the external communication apparatus via the communication unit 37 to thereby receive data from the external communication apparatus and transmit data to the external communication apparatus.

The rechargeable impact driver 1 of the first embodiment is produced as a specialized tool for wood screw as mentioned above. A specialized tool for wood screw is usually designed such that the impact mechanism 6 can withstand a torque that is expected during tightening operation of a wood screw. In other words, a specialized tool for wood screw is mostly not designed to be used for tightening a machine screw.

Accordingly, when a specialized tool for wood screw is used to tighten a machine screw into a metal workpiece, an unexpectedly large external torque (which is unlikely to be generated during tightening of a wood screw) might be applied while impacting is performed, resulting in damage to the impact mechanism 6, other mechanisms, various components, and the like.

It is, therefore, desirable for the rotary impact tool to have a protective function to avoid occurrence of failure, such as damage, to the rotary impact tool. For example, it is desirable that the type of a workpiece be automatically discriminated and the protective function work as necessary if it is determined that the current tightening operation is performed to a workpiece different from a workpiece corresponding to the rotary impact tool. That is, it is desirable to perform an appropriate motor control depending on the type of a workpiece.

Japanese Unexamined Patent Application Publication No. 2010-247326 includes a proposal for a technique to discriminate a workpiece. According to the invention in the Publication, the motor is first rotated at a low rotation number. If an impact has not occurred, the workpiece is determined to be a soft material; if an impact has occurred, the workpiece is determined to be a hard material, and the rotation number of the motor is increased.

This technique enables determination of whether a workpiece is soft or hard. However, low speed driving of the motor at the startup is required to discriminate a workpiece, which might lead to a longer time required for discrimination and thus to a prolonged entire operation time. In order not to deteriorate work efficiency of an operator, it is desirable that discrimination of a workpiece and appropriate motor control based on the discrimination result be performed rapidly.

The rechargeable impact driver 1 of the first embodiment is configured to discriminate a workpiece after a start of application of an impact and to reduce or stop the output of the motor 4 if it is determined that the workpiece is not wood but a relatively hard material, such as metal.

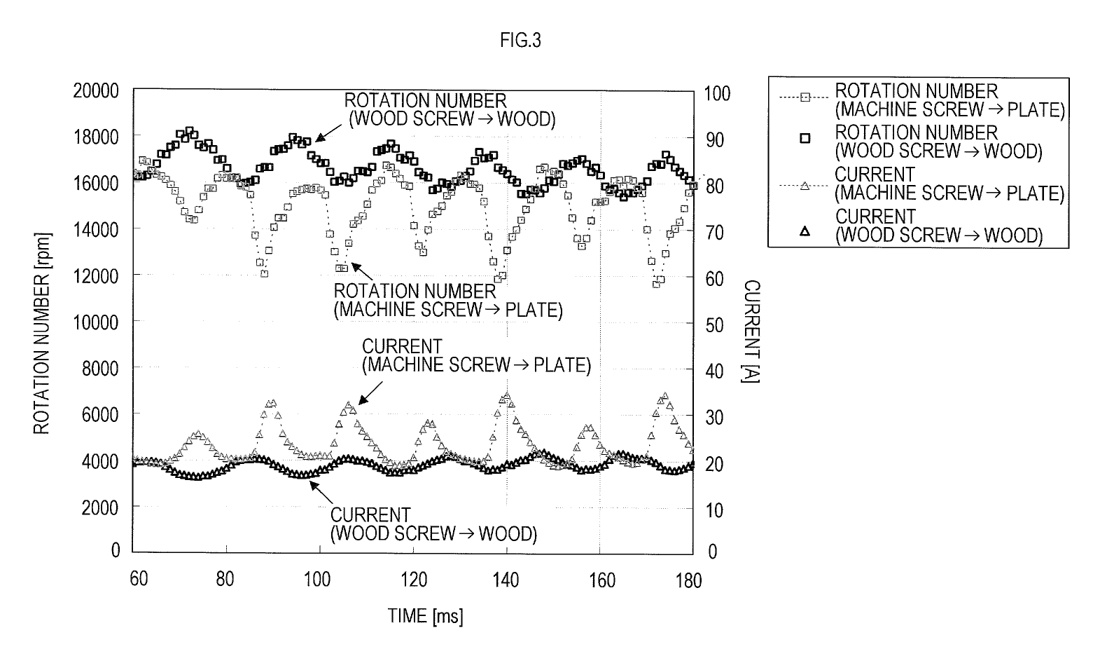

A description will be given of a method for discriminating a workpiece in the first embodiment with reference to FIG. 3. “During impacting” here means a time period while an impact is applied periodically (intermittently) after the start of application of an impact.

In a case of tightening a rotation object, such as a machine screw or a bolt, into a workpiece, when the trigger 21a is pulled to rotate the motor 4, the motor 4 rotates at high speed due to a substantially no-load state until the rotation object is seated on the workpiece.

“Load” here means a torque (load torque) applied externally to the tool element. In other words, “load” means a rotational torque required to rotate the tool element (i.e., to rotate the sleeve 19). The “no-load state” means a state where the load is smaller than a specified value and impacting is not performed.

When tightening of the rotation object proceeds and the rotation object becomes seated on the workpiece, the load is increased so that the load torque (rotational torque) reaches or exceeds the specified value and an impact is started. During impacting, the load is large, and thus the rotation number of the motor 4 is reduced compared with the rotation number in the no-load state.

FIG. 3 shows an example of fluctuations in the rotation number and the current after the start of application of an impact in a case of tightening a wood screw (the workpiece is wood) using the rechargeable impact driver 1, and an example of fluctuations in the rotation number and the current after the start of application of an impact in a case of tightening a machine screw (the workpiece is a metal plate) using the rechargeable impact driver 1.

As clear from FIG. 3, the rotation number and the current of the motor 4 periodically fluctuate during impacting as a result of the impacting action. Specifically, the rotation number and the current of the motor 4 periodically fluctuate in synchronization with the rotation of the hammer 14.

When an impact is applied, the rotation number of the motor 4 becomes a minimum value at the time that the hammer 14 rides over the anvil 15 (immediately before leaving the anvil 15 after riding over), and the current of motor 4 becomes a maximum value. At the time that the hammer 14 strikes the anvil 15 again after leaving the anvil 15 (i.e., immediately before an impact force is applied), the rotation number of the motor 4 becomes a maximum value, and the current of the motor 4 becomes a minimum value.

Accordingly, during impacting, each time the hammer 14 rotates, the rotation number and the current of the motor 4 fluctuate in synchronization with the rotation of the hammer 14. Specifically, the rotation number and the current of the motor 4 fluctuate in synchronization with the cycle of application of an impact.

The aforementioned minimum value in the periodically fluctuating rotation number or current is a minimal value according to the mathematically strict definition, whereas the aforementioned maximum value is strictly a maximal value. Accordingly, the periodical fluctuations of the rotation number and the current during impacting mean, strictly, that the maximal value and the minimal value occur alternately.

In the first embodiment, however, the maximal value and the minimal value of each of the rotation number and the current that occur during impacting are referred to as the maximum value and the minimum value as aforementioned, for convenience of description.

As clear from FIG. 3, the state of fluctuations in the rotation number and the current of the motor 4 during impacting is different between the case where the workpiece is a plate (i.e., the case of tightening a machine screw into a metal plate) and the case where the workpiece is wood (i.e., the case of tightening a wood screw into a wood workpiece).

In the case of tightening a wood screw into wood, a load starts to be applied to the tool element when a tip end of the wood screw enters the wood. The load gradually increases as the tightening proceeds. When the load reaches or exceeds a specified value, application of an impact starts. In the impact that occurs during the tightening of the wood screw, when the hammer 14 strikes the anvil 15, the anvil 15 is rotated to some extent due to the force received from the hammer 14, and the tightening of the wood screw proceeds by the extent of the rotation.

That is, in the case of tightening the wood screw, shock at the time of the impact is absorbed to some extent by the rotation of the anvil 15. As a result, the load does not change greatly, and the rotation number and the current of the motor 4 fluctuate sinusoidally with a relatively small fluctuation width as shown in FIG. 3.

In contrast, in the case of tightening a machine screw into a metal plate, application of an impact starts basically after the machine screw is seated on the metal plate (or immediately before the seating). Accordingly, in the case of tightening a machine screw, the rotation amount of the anvil 15 is small even when application of an impact starts after the seating, and large loads are applied to the anvil 15 and the motor 4 each time an impact is applied. That is, the load changes greatly at the time of an impact in the case of tightening a machine screw. As a result, the rotation number and the current of the motor 4 fluctuate with a relatively large fluctuation width as shown in FIG. 3.

Accordingly, in the first embodiment, the CPU 41 detects occurrence or non-occurrence of an impact based on a width of periodic fluctuation (fluctuation width) of the rotation number or the current of the motor 4 that occurs in synchronization with the cycle of application of an impact. Specifically, a specified threshold value (a detection threshold value) of the fluctuation width is set, and it is determined that an impact is applied if the fluctuation width reaches or exceeds the detection threshold value. In the present specification, a fluctuation width in any of various physical quantities (physical quantities, such as the rotation number and the current of the motor 4, that can fluctuate in synchronization with the cycle of application of an impact) means a width of fluctuation that occurs in synchronization with the cycle of application of an impact unless otherwise specifically defined.

As described above, when the hammer 14 strikes the anvil 15 (immediately before an impact force is applied), the rotation number of the motor 4 becomes maximum, and the current flowing in the motor 4 becomes minimum. In the first embodiment, therefore, in the case of detecting occurrence or non-occurrence of an impact based on the fluctuation width of the rotation number of the motor 4, each time the rotation number exhibits a maximum value in the process of the fluctuation, a difference between the maximum value and an immediately preceding minimum value is used as a fluctuation width, and occurrence or non-occurrence of impacting is detected based on the fluctuation width. In the case of detecting occurrence or non-occurrence of an impact based on the fluctuation width of the current of the motor 4, each time the current value exhibits a minimum value in the process of the fluctuation, a difference between the minimum value and an immediately preceding maximum value is used as a fluctuation width, and occurrence or non-occurrence of an impact is detected based on the fluctuation width.

It is not necessarily required to detect occurrence or non-occurrence of an impact based on the fluctuation width of the physical quantity, such as the rotation number or the current. Occurrence or non-occurrence of an impact may be detected by another method. For example, there may be a method for detecting a shock at the time of an impact or an impact sound using a shock sensor or a piezoelectric sensor, or a microphone, and subsequently detecting occurrence or non-occurrence of an impact based on the detected shock or impact sound.

Upon detection of a start of application of an impact, the CPU 41 discriminates a workpiece based on the fluctuation width of the rotation number or the fluctuation width of the current of the motor 4 during impacting. Specifically, it is determined whether tightening into a workpiece corresponding to the rechargeable impact driver 1 is performed or tightening into a relatively hard workpiece, such as a metal plate, is performed.

As described above, in the case of tightening a wood screw, a rotation angle of the anvil 15 per impact (and thus a rotation angle of the tool element and of the wood screw) (hereinafter also referred to as a “load axis rotation angle”) is relatively large, and the fluctuation widths of the rotation number and the current of the motor 4 are relatively small. In contrast, in the case of tightening a machine screw, the load axis rotation angle per impact is relatively small (or there may be little rotation), and fluctuation widths of the rotation number and the current of the motor 4 are relatively large.

Accordingly, upon detection of a start of application of an impact based on the fluctuation width of the rotation number or the current, the CPU 41 discriminates a workpiece based on the fluctuation width. Specifically, if the fluctuation width is less than a specified fluctuation width threshold value, it is determined that tightening of a wood screw into wood or the like is being performed, whereas if the fluctuation width is equal to or greater than the specified fluctuation width threshold value, a temporary determination is made that tightening of a machine screw or the like into a hard workpiece, such as metal, is being performed. After making such temporary determination a plurality of number of times, and the number of times of determination that the fluctuation width is equal to or greater than the fluctuation width threshold value, the CPU 41 makes a conclusive determination that tightening of a machine screw or the like into a hard workpiece, such as metal, is being performed. After the conclusive determination, the CPU 41 reduces the output of the motor 4 or stops the motor 4.

The fluctuation width threshold value is set to a specified value that is larger than a detection threshold value used to detect occurrence or non-occurrence of an impact. Also, discrimination of a workpiece after a start of application of an impact is designed to be performed within ten impacts from the start of application of the impact in the first embodiment. Specifically, if the number of times that the fluctuation width is equal to or greater than the fluctuation width threshold value has not reached a specified number of times by the time ten impacts have been applied, it is determined that the workpiece is a soft workpiece, such as wood, and no further discrimination is performed. Thus, in the first embodiment, the specified number of times is set to a specified value equal to or less than ten.

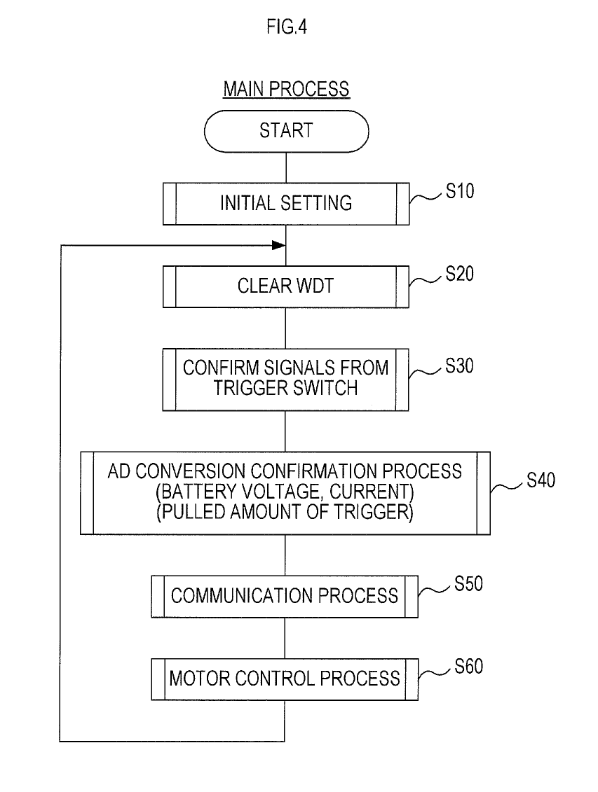

Next, a description will be given of a main process to be executed by the CPU 41 with reference to FIG. 4. When the CPU 41 is activated by power supply and starts operating, the CPU 41 reads a program of the main process in FIG. 4 from the memory 42 and executes the program.

When starting the main process in FIG. 4, the CPU 41 makes various initial settings in S10, and clears a watchdog timer (WDT) in S20. Later-described various flags and counters are all cleared in the initial settings in S10. In S30, a trigger-on signal and an operation signal from the trigger switch 21 are confirmed. Specifically, operation details of the trigger 21a are confirmed.

In S40, an AD conversion confirmation process is performed. Specifically, AD conversion of each of various analog input signals, including an operation signal from the trigger switch 21, a current detection signal from the current detection unit 35, and a voltage detection signal from the battery voltage detection unit 36, is performed to obtain various data after conversion, including the pulled amount of the trigger 21a, the current of the motor 4, and the voltage of the battery 29.

In S50, a communication process is performed. Specifically, data communication with an external communication apparatus is performed via the communication unit 37. If a communicable communication apparatus is not present, no process is performed in S50, and the present process proceeds to S60.

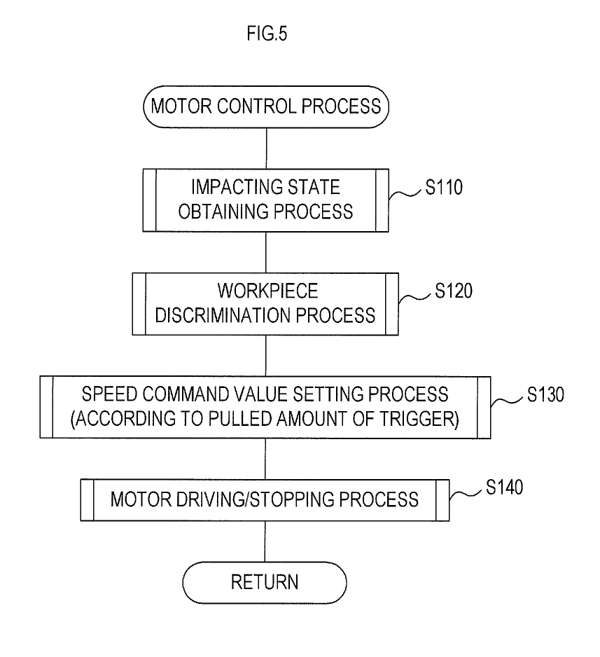

In S60, a motor control process is executed based on various information confirmed or obtained in the processes in S30 to S50. The details of the motor control process in S60 are as shown in FIG. 5.

When proceeding to the motor control process, the CPU 41 executes an impacting state obtaining process in S110. In the impacting state obtaining process, the rotation number or the current of the motor 4 is first obtained. It may be appropriately determined in advance which of the rotation number and the current should be obtained. Then, it is determined whether an impact has occurred based on the obtained rotation number or current.

For example, in the case of determination based on the rotation number, if the rotation number had been on the increase by the time of a previous obtainment and the currently obtained rotation number is smaller than the previously obtained rotation number (that is, if the rotation number turns from increase to decrease), an impact may have been applied.

In this case, the previously obtained rotation number is regarded as a maximum value. If a minimum value is detected before the maximum value, it can be determined that a fluctuation has occurred with a fluctuation width that is a difference between the minimum value and the previously obtained maximum value. Then, the CPU 41 computes and temporarily stores the fluctuation width of the rotation number in the memory 42.

Subsequently, it is determined whether an impact has occurred based on whether the fluctuation width is equal to or greater than the detection threshold value (the detection threshold value corresponding to the rotation number). If the fluctuation width is equal to or greater than the detection threshold value, it is determined that an impact has occurred, and an impact number counter is incremented (increased by one).

The impact number counter is a software counter that is temporarily created by the CPU 41 in a specified area of the memory 42, and is reset to “0” in the initial state. The initial state means when the CPU 41 is activated or when the trigger switch 21 is turned off. Thus, when an impact is detected for the first time after the CPU 41 is activated, the impact number counter is incremented from “0” to “1”.

Alternatively, in the case of determination of occurrence or non-occurrence of impacting based on the current, for example, if the current had been on the decrease by the time of a previous obtainment and the currently obtained current value is greater than the previously obtained current value (that is, if the current turns from decrease to increase), an impact may have been applied.

In this case, the previously obtained current value is regarded as a minimum value. If a maximum value is detected before the minimum value, it can be determined that a fluctuation has occurred with a fluctuation width that is a difference between the maximum value and the previously obtained minimum value. Also in this case, the CPU 41 computes and temporarily stores the fluctuation width of the current in the memory 42.

Subsequently, it is determined whether an impact has occurred based on whether the fluctuation width is equal to or greater than the detection threshold value (the detection threshold value corresponding to the current). If the fluctuation width is equal to or greater than the detection threshold value, it is determined that an impact has occurred, and the impact number counter is incremented (increased by one).

As described above, each time the CPU 41 proceeds to the process in S110, the CPU 41 obtains the rotation number or the current and makes an attempt to detect a fluctuation width of the rotation number or the current. If a fluctuation width indicating the possibility of occurrence of an impact is detected (if an immediately preceding change from a minimum value to a maximum value occurs in the case of the rotation number, whereas if an immediately preceding change from a maximum value to a minimum value occurs in the case of the current), the CPU 41 temporarily stores the fluctuation width and determines occurrence or non-occurrence of an impact based on the fluctuation width. If the CPU 41 determines that an impact is applied, the CPU 41 cumulatively adds the number of impacts by using the impact number counter.

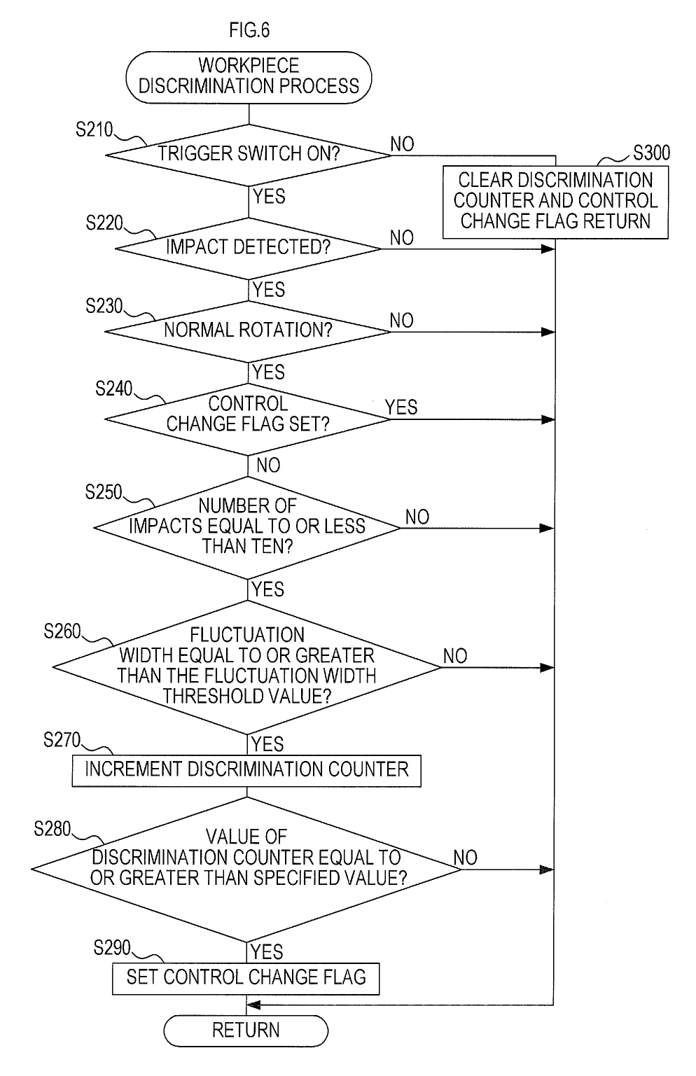

In S120, a workpiece discrimination process to discriminate a workpiece is performed. Details of the workpiece discrimination process in S120 are shown in FIG. 6. When proceeding to the workpiece discrimination process, the CPU 41 determines in S210 whether the trigger switch 21 is turned on based on presence or absence of a trigger-on signal from the trigger switch 21. If the trigger switch 21 is not turned on, a discrimination counter and a control change flag are cleared in S300, the workpiece discrimination process is terminated, and the present process proceeds to S130 (see FIG. 5). If the trigger switch 21 is turned on, the present process proceeds to S220.

In S220, it is determined whether an impact is detected. The determination is made based on whether an impact is detected in the immediately preceding impacting state obtaining process in S110. If an impact is not detected, the workpiece discrimination process is terminated, and the present process proceeds to S130 (see FIG. 5). If an impact is detected, the present process proceeds to S230.

In S230, it is determined whether the rotation of the motor 4 is set to the normal rotation based on a signal from the forward/reverse changeover switch 22, i.e., whether the rotational direction is set to the forward direction. If the rotational direction is set to the reverse direction, the workpiece discrimination process is terminated, and the present process proceeds to S130 (see FIG. 5). If the rotational direction is set to the forward direction, the present process proceeds to S240.

In S240, it is determined whether the control change flag is set. The control change flag is cleared (reset) in the initial state, and is set in a later-described process in S290. If it is determined in S240 that the control change flag is set, the workpiece discrimination process is terminated and the present process proceeds to S130 (see FIG. 5). If the control change flag is not set, the present process proceeds to S250.

In S250, it is determined whether the number of impacts since the start of rotation is equal to or less than ten. Specifically, it is determined whether the counter value of the impact number counter is equal to or less than ten. If the number of impacts is eleven or more, the workpiece discrimination process is terminated and the present process proceeds to S130 (see FIG. 5). If the number of impacts is equal to or less than ten, the present process proceeds to S260.

In S260, it is determined whether the fluctuation width (the fluctuation width of the rotation number or the current) that is temporarily stored in the memory 42 when an impact is detected in the immediately previous S110 (FIG. 5) is equal to or greater than the fluctuation width threshold value. If the fluctuation width is less than the fluctuation width threshold value, the workpiece discrimination process is terminated and the present process proceeds to S130 (see FIG. 5). That is, if the fluctuation width is less than the fluctuation width threshold value, it is determined that tightening into a soft workpiece, such as wood, is being performed. In this case, the motor 4 is driven by a speed command value according to the pulled amount of the trigger 21a as described later. On the other hand, if the fluctuation width is equal to or greater than the fluctuation width threshold value, the present process proceeds to S270.

In S270, the discrimination counter is incremented. The discrimination counter, which is a software counter like the impact number counter, is reset to “0” in the initial state. The discrimination counter is a counter to cumulatively add the number of determinations that the fluctuation width is equal to or greater than the fluctuation width threshold value. In S270, the discrimination counter is incremented by one.

In S280, it is determined whether the value of the discrimination counter is equal to or greater than a specified value. If the value of the discrimination counter is less than the specified value, the workpiece discrimination process is terminated and the present process proceeds to S130 (see FIG. 5). If the value of the discrimination counter is equal to or greater than the specified value, the present process proceeds to S290.

In S290, the control change flag is set. Specifically, when the number of the fluctuation width becoming equal to or greater than the fluctuation width threshold value has reached a specified number, a conclusive determination is made that tightening of a machine screw or the like into a hard workpiece, such as metal, is being performed, and the control change flag is set. After the control change flag is set in S290, the present process proceeds to S130 (see FIG. 5).

Returning to FIG. 5, a continued description will be given. Subsequent to the workpiece discrimination process (see FIG. 6 for details) in S120, a speed command value setting process is executed in S130. The speed command value setting process is basically a process to set a speed command value (a duty ratio in the first embodiment) according to the pulled amount of the trigger 21a. The details of setting vary depending on the state of the control change flag.

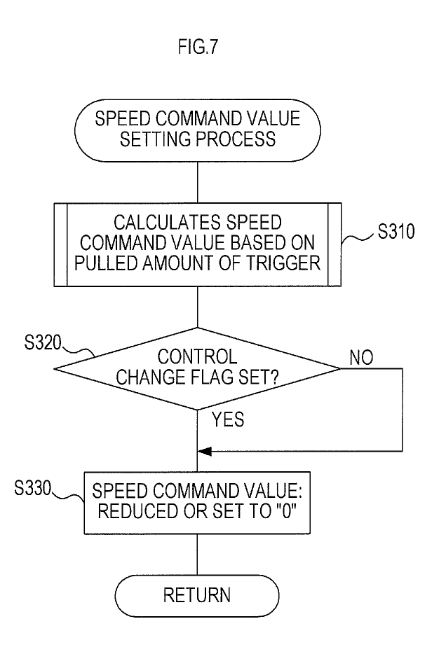

FIG. 7 shows the details of the speed command value setting process in S130. When proceeding to the speed command value setting process, the CPU 41 calculates a speed command value according to the pulled amount (obtained in S40) of the trigger 21a in S310. Specifically, a duty ratio according to the pulled amount is calculated.

In S320, it is determined whether the control change flag is set. If the control change flag is not set, the speed command value setting process is terminated, and the present process proceeds to S140 (FIG. 5). If the control change flag is set, the present process proceeds to S330.

In S330, setting change (correction) of the speed command value (the duty ratio) to a value lower than the value calculated in S310 is performed. Specifically, the speed command value is reduced to a specified value that is lower than the value calculated in S310 and also is larger than “0”, or is set to “0”. A reduction of the speed command value results in a corresponding reduction of the rotation number of the motor 4; setting of the speed command value to “0” results in stopping of the rotation of the motor 4.

As already mentioned above, when the control change flag is set, tightening of a machine screw or the like into a hard workpiece, such as metal, is being performed. Since the rechargeable impact driver 1 of the first embodiment is a specialized tool for wood screw, if the motor 4 is rotated during the tightening of a machine screw at a rotation number according to the pulled amount of the trigger 21 in the same manner as in the case of the tightening of a wood screw, the tool might be damaged. Accordingly, it is configured such that, when the control change flag is set, the speed command value is reduced and the rotation is continued, or the speed command value is set to “0” to thereby stop rotation, so that damage to the tool can be inhibited. Subsequent to the process in S330, the present process proceeds to S140 (FIG. 5).

The reduction of the speed command value in S330 does not necessarily mean a reduction to such an extent that an impact does not occur. For example, it may be configured such that the impact force is reduced, while application of an impact is allowed to continue, to thereby reduce mechanical shock. Of course, it may be configured such that the speed command value is reduced sufficiently to such an extent that an impact does not occur.

Returning to FIG. 5, a continued description will be given. In S140, a motor driving/stopping process is executed. Specifically, a duty signal indicated by the speed command value (duty ratio) set in the S130 is outputted to the gate circuit 32 as a drive signal. As a result, the motor 4 is driven at the set duty ratio.

In the rechargeable impact driver 1 of the first embodiment, as described above, when detecting an impact, the CPU 41 controls the driving of the motor 4 according to the fluctuation width of the physical quantity that fluctuates due to the impact. Accordingly, the motor 4 is appropriately controlled according to the state of impacting, and thus an operator can perform an operation using an impact force.

Particularly in the first embodiment, the rotation number of the motor 4 or the current flowing in the motor 4 is used as the physical quantity, and driving of the motor 4 is controlled based on the fluctuation width of the rotation number or the current after an impact is detected. The rotation number and the current of the motor 4 are physical quantities that fluctuate in synchronization with application of an impact (at the same cycle as that of application of an impact) and thus are physical quantities that better represent the state of impacting. Accordingly, by the control using the fluctuation width of the rotation number or the current, drive control of the motor 4 while impacting is performed can be performed more accurately and efficiently in view of the state of impacting.

When the fluctuation width of the rotation number or the current reaches or exceeds the fluctuation width threshold value after the start of application of an impact, the CPU 41 performs a driving force limiting control to reduce the speed command value from the value according to the pulled amount of the trigger 21a and continue driving of the motor 4, or to set the speed command value to “0” to stop the motor 4.

Accordingly, if a relatively high load is applied during use as, for example, in the case of tightening a machine screw using a specialized tool for wood screw, occurrence of abnormality or failure to the rechargeable impact driver 1 due to the high load can be inhibited.

Also, the driving force limiting control is performed not immediately after the fluctuation width of the rotation number or the current reaches or exceeds the fluctuation width threshold value after the start of impacting, but after the number of times when the fluctuation width becomes equal to or greater than the fluctuation width threshold value has reached a specified number or more. Accordingly, it is possible to detect the fluctuation width that occurs due to the impact more accurately, and thus it is possible to determine accurately whether to perform the driving force limiting control.

Further, the CPU 41 does not perform the driving force limiting control when the rotational direction is set to the reverse direction. Specifically, when the rotational direction is set to the reverse direction, output from the motor 4 is not reduced or the motor 4 is not stopped even if an impact is applied and the fluctuation width of the rotation number or the current at the time reaches or exceeds the fluctuation width threshold value. Accordingly, in the case of loosening a rotation object, such as a screw or a bolt, from the workpiece, the loosening can be performed efficiently and rapidly.

Moreover, the CPU 41 does not perform the driving force limiting control if the number of impacts exceeds ten after the start of impacting. If the value of the discrimination counter has not reached or exceeded a specified value although the number of impacts is ten or less, it is assumed that tightening of a wood screw is being performed.

In the case of tightening a wood screw using a specialized tool for wood screw, unlike the case of tightening a machine screw, reduction of the output of the motor 4 or stopping of the motor 4 during impacting might result in reduced operability of an operator. Accordingly, if the value of the discrimination counter has not reached or exceeded a specified value although the number of impacts is ten or less, the driving force limiting control is not performed to thereby inhibit reduction in operability or work efficiency.

### Second Embodiment

Next, a description will be given of a rechargeable impact driver of a second embodiment. A mechanical configuration of the rechargeable impact driver of the second embodiment is the same as the mechanical configuration of the rechargeable impact driver 1 of the first embodiment shown in FIG. 1. Also, the hardware configuration in the electrical configuration is the same as that of the first embodiment shown in FIG. 2. Therefore, the description of the second embodiment will be given with reference to FIG. 1 and FIG. 2.

A rechargeable impact driver 1 of the second embodiment may be a specialized tool for wood screw as in the first embodiment, or may be a tool other than a specialized tool for wood screw (for example, a machine screw compatible tool).

In general, when performing a tightening operation of a screw or a bolt using a rotary impact tool, an operator turns off a tool switch to stop the action (stop application of an impact) of the tool at an appropriate timing after the start of application of an impact. It usually depends largely on the operator's experience and/or skill level at what timing application of an impact should be stopped; the operator cannot always stop impacting at an appropriate timing.

As a result, unnecessary impacts might be applied, causing an excessive tightening, a stripped screw head, or a broken-off screw head. In contrast, an insufficient number of impacts might cause an insufficient tightening force.

To solve these problems, the present inventor has conceived a control method in which a load shaft rotation angle since the start of impacting is detected cumulatively, and when the load shaft rotation angle since the start of impacting has reached a specified rotation angle, the motor is automatically stopped or its output is reduced (the rotation number is reduced). In the second embodiment, a description will be given of an example in which the control method is applied to the rechargeable impact driver 1.

The load shaft rotation angle generated by each impact varies depending on the pulled amount of the trigger 21a as well as depending on the workpiece even with respect to the same pulled amount (i.e., the same duty ratio). Also, as the load shaft rotation angle by each impact is larger, the respective fluctuation widths of the rotation number and the current are smaller.

When tightening into a relatively soft workpiece, such as tightening of a wood screw into wood, is performed, the load shaft rotation angle by each impact is relatively large, and the respective fluctuation widths of the rotation number and the current of the motor 4 are relatively small. On the other hand, when tightening into a relatively hard workpiece, such as tightening of a machine screw into a metal plate, is performed, the start of application of an impact is close to the timing when the screw is seated. Accordingly, the load shaft rotation angle by each impact after the start of application of an impact is relatively small (or substantially zero), and the respective fluctuation widths of the rotation number and the current of the motor 4 are relatively large.

In the second embodiment, therefore, the CPU 41 estimates the load shaft rotation angle based on the current that flows in the motor 4 after the start of application of an impact (during impacting). When the load shaft rotation angle since the start of impacting has reached a specified set impact rotation angle (a preset value of an impact rotation angle), the speed command value is reduced or set to “0” to thereby reduce the output of the motor 4.

The second embodiment is configured such that the preset value of the impact rotation angle may be selectively set to one of a plurality of preset values. Specifically, in the second embodiment, the preset value of the impact rotation angle may be one of four angles 90°, 180°, 360°, and 720°. The setting can be performed by pressing the rotation angle changing switch 26 (see FIG. 2) provided in the operation panel 24.

Each time an operator presses the rotation angle changing switch 26, the preset value of the impact rotation angle changes in the order of 90°, 180°, 360°, 720°, continuous rotation, 90°, 180° . . . . Each time the preset value changes, the preset value after the change is displayed on the display unit 27 in the operation panel 24.

In a case where the preset value of the impact rotation angle is set to, for example, 180°, the speed command value is reduced or becomes “0” when the load shaft rotation angle has reached 180° after the start of application of an impact. The “continuous rotation” means that no preset value of the impact rotation angle is set, and thus the motor 4 continues to be driven at the speed command value according to the pulled amount of the trigger 21a, while the trigger 21a is on.

An operator can set the control details after the start of application of an impact to desired details by operating the rotation angle changing switch 26. For example, when it is desired to rapidly reduce the output of the motor 4 after the start of application of an impact to thereby perform tightening at a lower torque, a lower preset value, such as 90° or 180°, should be selected.

Conversely, when it is desired to perform firm tightening by a strong impact force for a while after the start of application of an impact, and then reduce the output, a higher preset value, such as 360° or 720°, should be selected. When it is desired not to reduce the output of the motor 4 even after the start of application of an impact regardless of the load shaft rotation angle, the “continuous rotation” should be selected.

In the initial state after the CPU 41 is activated, the preset value of the impact rotation angle is set to “continuous rotation”. The preset value of the impact rotation angle may be set via wireless communication from an external communication apparatus other than via the operation of the rotation angle changing switch 26. When setting data of a preset value of the impact rotation angle from an external communication apparatus is received by the communication unit 37, the CPU 41 sets the preset value of the impact rotation angle based on the setting data.

There may be various specific methods to determine the load shaft rotation angle based on the fluctuation width of the current flowing in the motor 4. As already described above, it is expected that as the fluctuation width of the current at the time of an impact is larger, the load shaft rotation angle per impact is smaller; whereas it is expected that as the fluctuation width of the current at the time of an impact is smaller, the load shaft rotation angle per impact is larger.

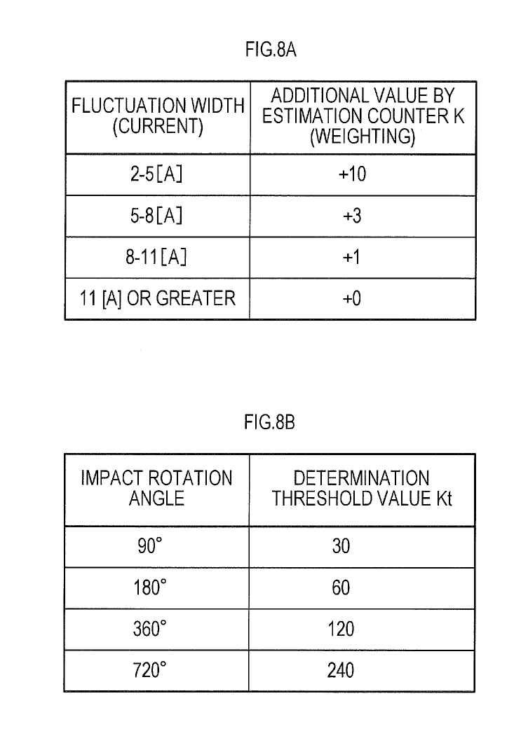

In the second embodiment, therefore, the fluctuation width of the current is classified stepwisely into a plurality of ranges, and weighting values (additional values), each corresponding to the fluctuation width of each of the ranges (i.e., corresponding to the load shaft rotation angle expected from the fluctuation width), are set to the respective ranges. Specifically, a weighting table shown in FIG. 8A is stored in the memory 42 of the control circuit 31.

In the weighting table of FIG. 8A, the fluctuation width of the current is classified into four ranges, and an additional value (a weighting value) is set to each of the four ranges. Specifically, an additional value of +10 is set for the fluctuation width of the current 2-5 [A] (equal to or greater than 2 [A] and less than 5[A]), an additional value of +3 is set for the fluctuation width 5-8 [A] (equal to or greater than 5 [A] and less than 8 [A]), an additional value of +1 is set for the fluctuation width of 8-11 [A] (equal to or greater than 8 [A] and less than 11 [A]), and an additional value of “0” is set for the fluctuation width of 11 [A] or greater. A greater additional value (weighting value) means that the load shaft rotation angle per impact is larger.

Each time of detection of an impact based on the fluctuation width of the current, the CPU 41 refers to the weighting table and cumulatively adds the additional value corresponding to the fluctuation width by means of an estimation counter K. When the value of the estimation counter K has reached a value (a determination threshold value Kt) corresponding to the preset value of the impact rotation angle, the speed command value is reduced or set to “0”. Respective determination threshold values Kt corresponding to the four preset values of the impact rotation angle are previously stored in the memory 42 as a threshold value table shown in FIG. 8B.

In the second embodiment, the CPU 41 also executes the main process shown in FIG. 4 in the same manner as in the first embodiment. In the second embodiment, the aforementioned preset value of the impact rotation angle can be obtained from an external communication apparatus in the communication process in S50 of the main process. In the second embodiment, the motor control process in S60 of the main process in FIG. 4 is different from that in the first embodiment.

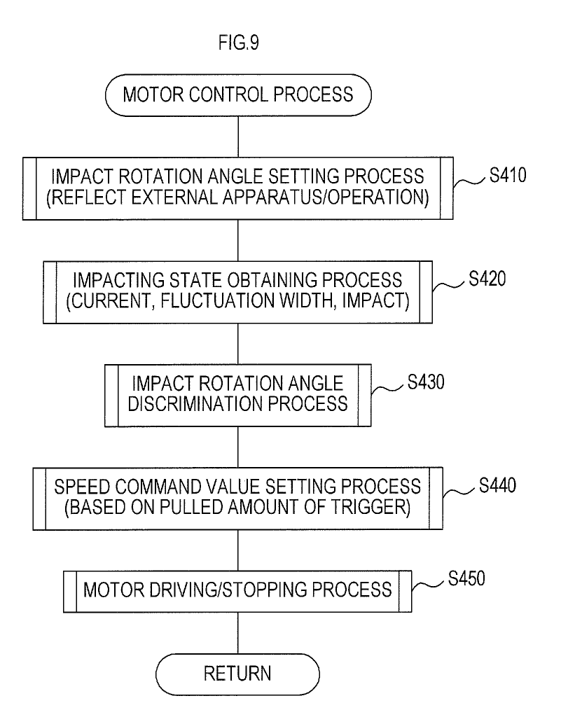

FIG. 9 shows the motor control process of the second embodiment. When starting the motor control process in FIG. 9, the CPU 41 executes an impact rotation angle setting process in S410. This impact rotation angle setting process is a process to set a preset value of the impact rotation angle based on setting data from an external communication apparatus or based on the setting details of the rotation angle changing switch 26.

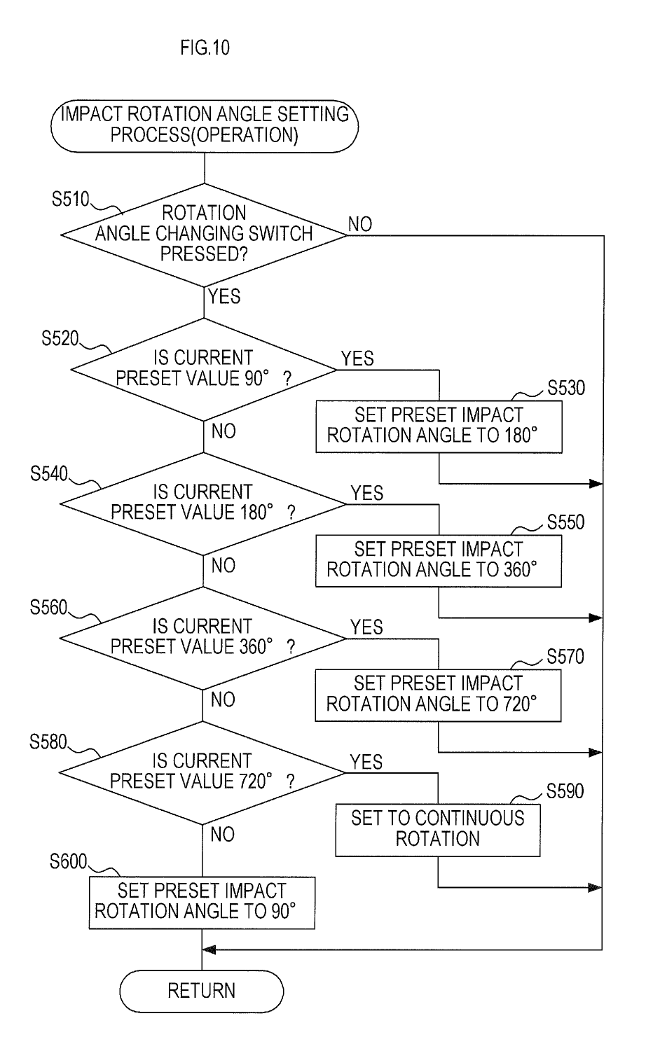

In S410, if setting data from the communication apparatus is received, a preset value of the impact rotation angle is set based on the setting data, and the present process proceeds to S420. If setting data from the communication apparatus is not received, a process shown in FIG. 10 to reflect the setting details of the rotation angle changing switch 26 is executed as the impact rotation angle setting process.

When starting the impact rotation angle setting process in FIG. 10, the CPU 41 determines in S510 whether the rotation angle changing switch 26 is pressed. If the rotation angle changing switch 26 is not pressed, the impact rotation angle setting process is terminated, and the present process proceeds to S420 (see FIG. 9). If the rotation angle changing switch 26 is pressed, the present impact rotation angle setting process proceeds to S520.

In S520, it is determined whether the current preset value is 90°. If the current preset value is 90°, the present process proceeds to S530, and the preset value is set to 180°. Subsequent to the process in S530, the present process proceeds to S420 (see FIG. 9). If the current preset value is not 90°, the present process proceeds to S540.

In S540, it is determined whether the current preset value is 180°. If the current preset value is 180°, the present process proceeds to S550, and the preset value is set to 360°. Subsequent to the process in S550, the present process proceeds to S420 (see FIG. 9). If the current preset value is not 180°, the present process proceeds to S560.

In S560, it is determined whether the current preset value is 360°. If the current preset value is 360°, the present process proceeds to S570, and the preset value is set to 720°. Subsequent to the process in S570, the present process proceeds to S420 (see FIG. 9). If the current preset value is not 360°, the present process proceeds to S580.

In S580, it is determined whether the current preset value is 720°. If the current preset value is 720°, the present process proceeds to S590, and the preset value is set to the “continuous rotation”. Subsequent to the process in S590, the present process proceeds to S420 (see FIG. 9). If the current preset value is not 720°, the present process proceeds to S600.

The fact that a negative determine is made in S580 and the present process proceeds to S600 means that the current setting state is a state of “continuous rotation”. Accordingly, in S600, the preset value is set to 90°. Subsequent to the process in S600, the present process proceeds to S420 (see FIG. 9).

Returning to FIG. 9, a continued description will be given. Subsequent to the impact rotation angle setting process in S410, an impacting state obtaining process to obtain a state of impacting is executed in S420. Specifically, the current flowing in the motor 4 is first obtained, and it is determined whether an impact has occurred based on the obtained current.

A method for determining occurrence of an impact based on the current is the same as the determination method in S110 of the motor control process of the first embodiment shown in FIG. 5. Specifically, if a fluctuation in the current occurs, occurrence or non-occurrence of an impact is detected based on the fluctuation width of the current. In the second embodiment as well, when an impact is detected based on the fluctuation width of the current, the fluctuation width is temporarily stored in the memory 42.

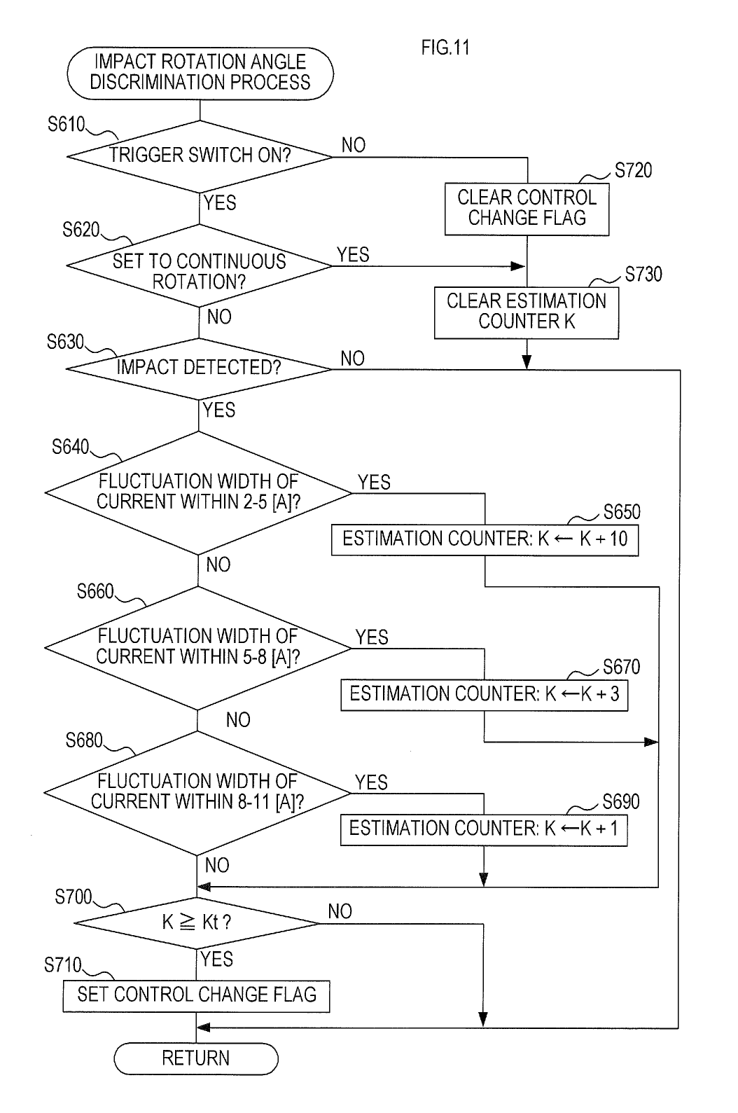

In S430, an impact rotation angle discrimination process is executed. The details of the impact rotation angle discrimination process in S430 are as shown in FIG. 11. When proceeding to the impact rotation angle discrimination process, the CPU 41 determines in S610 whether the trigger switch 21 is on.

If the trigger switch 21 is not on, the control change flag is cleared in S720, and the estimation counter K is cleared to “0” in S730. Subsequent to the process in S730, the present process proceeds to S440 (see FIG. 9). The estimation counter K is a software counter as with the respective counters described in the first embodiment. The estimation counter K indicates an estimated value of the load shaft rotation angle after the start of application of an impact.

If it is determined in S610 that the trigger switch 21 is on, it is then determined in S620 whether the preset value of the impact rotation angle is the “continuous rotation”. If it is set to the “continuous rotation”, the present process proceeds to S730, in which the estimation counter K is cleared. If it is not set to the “continuous rotation”, the present process proceeds to S630.

In S630, it is determined whether an impact has been detected. Specifically, it is determined whether an impact has been detected in the immediately previous impacting state obtaining process in S420. If an impact has not been detected, the impacting state discrimination process is terminated, and the present process proceeds to S440 (see FIG. 9). If an impact has been detected, the present process proceeds to S640.

In S640, it is determined whether the fluctuation width of the current (specifically, the latest current fluctuation width stored in the memory 42), based on which an impact has been detected in the immediately previous S420, is within a range of 2-5 [A] (equal to or greater than 2 [A] and less than 5 [A]).

If the current fluctuation width is within the range of 2-5 [A], the present process proceeds to S650, in which the estimation counter K is updated to a value obtained by adding ten to the current value. The additional value of ten is an additional value (weighting value) previously set corresponding to the current fluctuation width 2-5 [A] as illustrated in FIG. 8A. After updating the estimation counter K in S650, the present process proceeds to S700. If it is determined in S640 that the current fluctuation width is not within the range of 2-5 [A], the present process proceeds to S660.

In S660, it is determined whether the current fluctuation width is within a range of 5-8 [A] (equal to or greater than 5 [A] and less than 8 [A]). If the current fluctuation width is within the range of 5-8 [A], the present process proceeds to S670, in which the estimation counter K is updated to a value obtained by adding three to the current value. The additional value of three is an additional value (weighting value) previously set corresponding to the current fluctuation width 5-8 [A] as illustrated in FIG. 8A. After updating the estimation counter K in S670, the present process proceeds to S700. If it is determined in S660 that the current fluctuation width is not within the range of 5-8 [A], the present process proceeds to S680.

In S680, it is determined whether the current fluctuation width is within a range of 8-11 [A] (equal to or greater than 8 [A] and less than 11 [A]). If the current fluctuation width is within the range of 8-11 [A], the present process proceeds to S690, in which the estimation counter K is updated to a value obtained by adding one to the current value. The additional value of one is an additional value (weighting value) previously set corresponding to the current fluctuation width 8-11 [A] as illustrated in FIG. 8A. After updating the estimation counter K in S690, the present process proceeds to S700. If it is determined in S680 that the current fluctuation width is not within the range of 8-11 [A], the present process proceeds to S700.

In S700, it is determined whether the current value of the estimation counter K is equal to or greater than a determination threshold value Kt (see FIG. 8B) that corresponds to the currently set impact rotation angle. If K<Kt, the impact rotation angle discrimination process is terminated, and the present process proceeds to S440 (see FIG. 9). If K≧Kt, the present process proceeds to S710. The fact of being K≧Kt leads to an assumption that an accumulated load shaft rotation angle since the start of application of an impact has reached a set impact rotation angle. Thus, in S710, the control change flag is set.

Returning to FIG. 9, a continued description will be given. Subsequent to the impact rotation angle discrimination process in S430, a speed command value setting process is executed in S440. This speed command value setting process is the same as the setting process in FIG. 7 described in the first embodiment. Specifically, the speed command value (duty ratio) is set basically according to the pulled amount of the trigger 21a; if the control change flag is set, the speed command value is set to a specified value that is lower than a value according to the pulled amount of the trigger 21, or set to “0”.

In S450, a motor driving/stopping process is executed. Specifically, a duty signal indicated by the speed command value (duty ratio) set in S440 is outputted as a drive signal to the gate circuit 32. As a result, the motor 4 is driven at the set duty ratio.

As described above, according to the rechargeable impact driver 1 of the second embodiment, the load shaft rotation angle since the start of application of an impact is calculated after the start of application of the impact based on the fluctuation width of the current flowing in the motor 4. When the load shaft rotation angle has reached a set impact rotation angle, the output of the motor 4 is reduced and the driving of the motor 4 is continued, or the motor 4 is stopped.

Accordingly, it is possible to inhibit an excessive tightening by an impact force or turning off of the trigger switch 21 despite an insufficient tightening after the start of application of an impact. That is, tightening by an impact force can be performed without excess or deficiency.

Further, in the second embodiment, indicated in FIG. 8A, the possibly occurring fluctuation width of the current is classified into a plurality of levels, and additional values (weighting values) corresponding to the respective levels are set. Accordingly, it is possible to accurately calculate the load shaft rotation angle according to the fluctuation width of the current.

The respective additional values (weighting values) shown in FIG. 8A correspond to an example of a unit impact rotation angle of the present invention, and the set impact rotation angle corresponds to an example of a specified rotation angle of the present invention. The amount of change (fluctuation width) from the maximum value to the minimum value of the current that occurs immediately before a detection of an impact corresponds to an example of a calculation target fluctuation width of the present invention.

### Third Embodiment

Next, a description will be given of a rechargeable impact driver of a third embodiment. The mechanical configuration of the rechargeable impact driver of the third embodiment is the same as the mechanical configuration of the rechargeable impact driver 1 of the first embodiment shown in FIG. 1. Also, the hardware configuration in the electrical configuration is the same as that of the first embodiment shown in FIG. 2. Therefore, the description of the third embodiment is given with reference to FIG. 1 and FIG. 2.

A rechargeable impact driver 1 of the third embodiment may be a specialized tool for wood screw as in the first embodiment, or may be a tool other than a specialized tool for wood screw (for example, a machine screw compatible tool).

In the rechargeable impact driver 1, the hammer 14 is forwardly biased by the coil spring 16. Accordingly, application of an impact might not be performed at an appropriate timing (at a timing that allows energy of the hammer 14 to be efficiently conveyed to tighten a rotation object into a workpiece properly and efficiently) depending on the rotation number at the time of application of an impact.

For example, when the rotation number of the motor 4 at the time of application of an impact is too small, the striking timing of the anvil 15 by the hammer 14 might be delayed due to the structure of the impact mechanism 6, so that the impact energy of the hammer 14 might not be conveyed to the anvil 15 efficiently. On the other hand, when the rotation number of the motor 4 at the time of application of an impact is too large, the striking timing of the anvil 15 by the hammer 14 might be too early due to the structure of the impact mechanism 6, so that loss of the impact energy of the hammer 14 might be caused.

Also, application of an impact might not be performed at an appropriate timing depending on the workpiece that is a target of tightening. In general, an impact mechanism provided to a rotary impact tool is designed to resist a torque that is expected during tightening operation of a rotation object. Some tools may be manufactured mainly for the purpose of tightening operation into a relatively soft workpiece (for example, wood).

If a rotary impact tool manufactured mainly for the purpose of tightening operation into a soft workpiece is used to tighten a machine screw into a hard workpiece, an unexpected excess load is applied to the load shaft of the tool. In this case, when the hammer strikes the anvil, the anvil hardly moves, and the hammer rebounds relatively largely in reaction to the impact. As a result, the timing of application of an impact during impacting might be deviated from an appropriate timing.

If application of an impact is not performed at an appropriate timing, operability and/or operation result might be deteriorated. Accordingly, in a rotary impact tool, spring force and/or other mechanisms are supposedly adjusted such that application of an impact at an appropriate timing can be performed within the scope of usually expected operating conditions (such as the rotation number during impacting and the type of a workpiece).

Actually, however, an impact cannot always be applied at an appropriate timing due to various factors, such as how a tool is used by an operator and conditions of a workpiece. Thus, it is desirable in a rotary impact tool that an impact be applied at an appropriate timing for improved energy efficiency and operability.

The present inventor has conceived a method for determining whether application of an impact at an appropriate timing is performed based on the fluctuation width of the rotation number or the current during impacting. Specifically, application of an impact at an appropriate timing is performed when the fluctuation width of the rotation number or the current of the motor 4 during impacting is within a specified range. This is also illustrated by an operational example shown in FIG. 3.

In the case of tightening a wood screw with a specialized tool for wood screw, the fluctuation widths of the rotation number and the current are small as shown in FIG. 3. In other words, application of an impact is performed at an appropriate timing and efficiently. In contrast, in the case of tightening a machine screw with a specialized tool for wood screw, the fluctuation widths of the rotation number and the current are large. In other words, application of an impact is not performed at an appropriate timing, and thus efficient application of an impact is not performed.

As described above, the fluctuation widths of the rotation number and the current of the motor 4 vary depending on whether application of an impact is performed at an appropriate timing. As a general tendency, the fluctuation widths of the rotation number and the current become larger as the timing of application of an impact becomes worse. That is, for example, inappropriate timing of application of an impact due to the material of a workpiece or inappropriate timing of application of an impact due to a too large or too small rotation number of the motor 4 results in changes in the fluctuation widths of the rotation number and the current of the motor 4.

According to the rechargeable impact driver 1 of the third embodiment, therefore, the speed command value is corrected (a fluctuation width feedback control of the speed command value is performed) after the start of application of an impact based on the fluctuation width of the rotation number during impacting. Specifically, the CPU 41 calculates, each time an impact is detected, a difference between the fluctuation width of the rotation number when the impact is detected and a previously set target fluctuation width, and corrects the speed command value so as to make the difference to “0” (specifically, such that an actual rotation number will match a target rotation number).

The CPU 41 corrects, during impacting, the speed command value according to the pulled amount of the trigger 21a by the fluctuation width feedback control as described above, and controls the motor 4 using the corrected speed command value.

There may be various specific ways to control the motor 4 using the speed command value corrected by the fluctuation width feedback control. For example, an open control to output a drive signal of a duty ratio according to the speed command value may be employed as in the first and second embodiments.

Alternatively, for example, it may be employed to compare the speed command value and an actual physical quantity corresponding to the speed command value, and to perform a feedback control of the duty ratio (output duty ratio) of a drive signal to be outputted ultimately to the gate circuit 32 such that the difference between the speed command value and the actual physical quantity.

For example, in the case of using the rotation number as the speed command value, a speed feedback control may be performed. Specifically, the output duty ratio may be controlled such that the speed command value (the rotation number) corrected by the fluctuation width feedback control and an actual rotation number become equal.

Further, for example, in the case of using the duty ratio as the speed command value, the following feedback control may be performed: the speed command value (the duty ratio) corrected by the fluctuation width feedback control and a current actual output duty ratio is compared and the output duty ratio is controlled such that the current actual output duty ratio and the output duty ratio become equal.

In the third embodiment, respective descriptions are given regarding a case of calculating the duty ratio as the speed command value and a case of calculating the rotation number as the speed command value.

In the third embodiment as well, the CPU 41 executes the main process shown in FIG. 4 as in the first embodiment. In the third embodiment, however, the motor control process in S60 of the main process in FIG. 4 is different from that in the first embodiment.

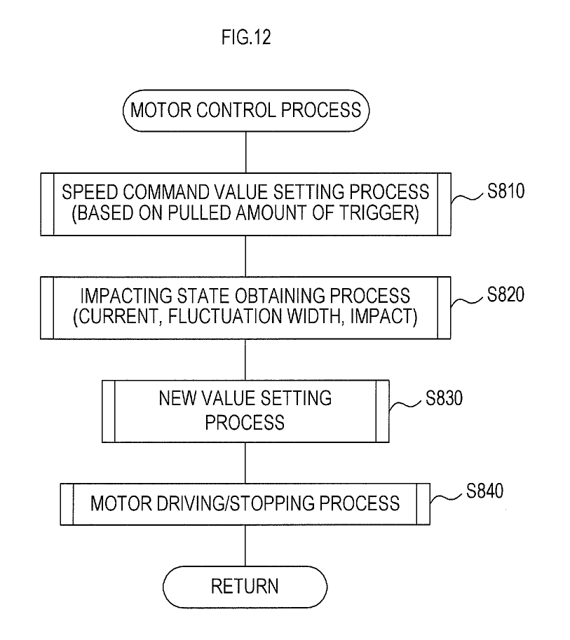

FIG. 12 shows the motor control process of the third embodiment. When starting the motor control process in FIG. 12, the CPU 41 executes a speed command value setting process in S810. Specifically, a speed command value (a rotation number or a duty ratio) according to the pulled amount of the trigger 21a is set (calculated). In a case where the speed command value is the rotation number, the calculated speed command value (the rotation number) becomes greater as the pulled amount is greater.

In S820, an impacting state obtaining process is executed. Specifically, the rotation number of the motor 4 is first obtained, and then it is determined whether an impact has occurred based on the obtained rotation number. A method for determination on occurrence of an impact based on the rotation number is the same as the method for determination in S110 of the motor control process of the first embodiment shown in FIG. 5.

Specifically, when a fluctuation of the rotation number (a fluctuation from a minimum value to a maximum value) occurs, occurrence or non-occurrence of an impact is detected based on the fluctuation width. In the third embodiment as well, when an impact is detected based on the fluctuation width of the rotation number, the fluctuation width is temporarily stored in the memory 42.

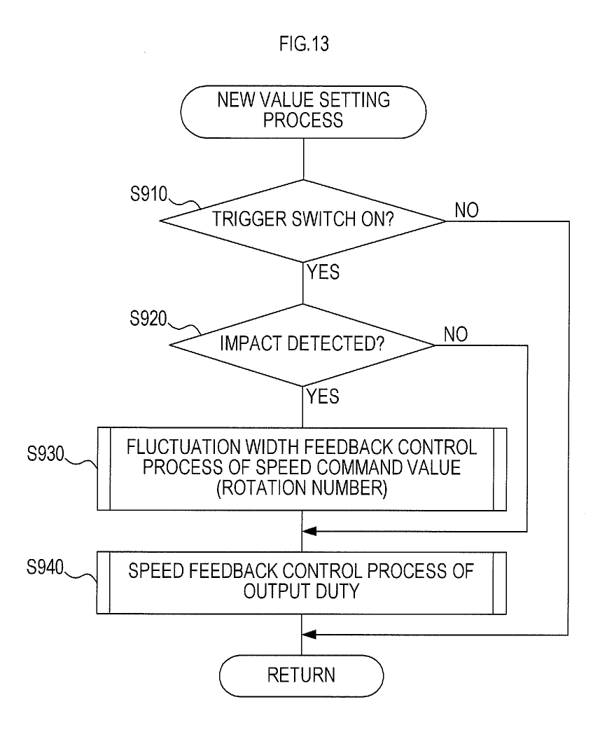

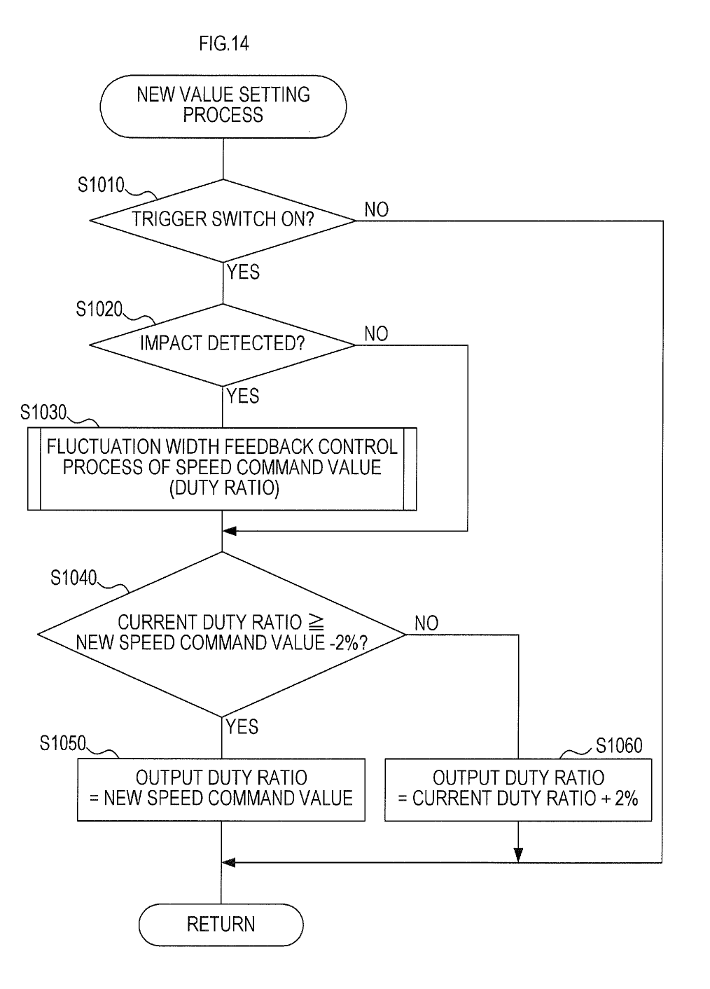

In S830, a new value setting process is executed. In the new value setting process, if an impact is detected in S820, a process to correct the speed command value (a fluctuation width feedback control) based on the fluctuation width of the rotation number at the time of the detection (the current fluctuation width) is executed. Further, by performing a feedback control of the corrected speed command value based on an actual physical quantity corresponding to the corrected speed command value, a duty ratio (an output duty ratio) of a duty signal to be outputted finally as a drive signal is calculated. Details of the process in S830 will be described later with reference to FIG. 13 and FIG. 14.

After calculating the final speed command value in the new value setting process in S830, a motor driving/stopping process is executed in S840. Specifically, based on the speed command value (the output duty ratio) calculated in S830, a duty signal indicating the output duty ratio is outputted to the gate circuit 32 as a drive signal. As a result, the motor 4 is driven at the output duty ratio calculated in S830.

A specific description will be given of the new value setting process in S830. First, a description will be given of a case of calculating a rotation number as the speed command value with reference to FIG. 13. In the case of calculating a rotation number as the speed command value, the CPU 41 executes a process shown in FIG. 13 as the new value setting process in S830.

When proceeding to the new value setting process in FIG. 13, the CPU 41 determines in S910 whether the trigger switch 21 is on. If the trigger switch 21 is not on, the new value setting process is terminated. If the trigger switch 21 is on, the present process proceeds to S920.

In S920, it is determined whether an impact has been detected. The determination is made based on whether an impact has been detected in the immediately previous impacting state obtaining process in S820. If an impact has not been detected, the present process proceeds to S940. If an impact has been detected, the present process proceeds to S930.

In S930, a fluctuation width feedback control process of the speed command value (the rotation number in the present example). The fluctuation width feedback control process is executed specifically by performing corrective calculation of the speed command value using the following Formula (1):

New speed command value=speed command value+(target fluctuation width−current fluctuation width)Ga (1)

In Formula (1), the speed command value on the right side is the current speed command value. For example, when the process in S830 is performed for the first time after the CPU 41 is activated, the current speed command value is a speed command value calculated in S810. For example, when the process in S830 is performed in the last control cycle, the current speed command value is a new speed command value last calculated in S830.

In Formula (1), the coefficient Ga of the second term on the right side is a proportionality coefficient. The target fluctuation width is an expected fluctuation width of the rotation number when application of an impact is performed at an appropriate timing. The target fluctuation width may be calculated theoretically or experimentally considering the type and the specification of the rechargeable impact driver 1 as well as the entire configuration of its impact mechanism 6 (such as the spring coefficient of the coil spring 16).

Whether application of an impact is performed at an appropriate timing can be confirmed by comparing the current fluctuation width of the rotation number at the time of the impact with the target fluctuation width. It can be said that, as the current fluctuation width is closer to the target fluctuation width, application of an impact is performed at a timing closer to an optimum timing. Reversely, it can be said that as a difference between the current fluctuation width and the target fluctuation width is greater, the deviation of an actual impact timing from an optimum timing becomes greater.

Accordingly, in the third embodiment, the current speed command value is corrected according to the difference between the current fluctuation width and the target fluctuation width in accordance with Formula (1). For example, when the current fluctuation width is greater than the target fluctuation width, a speed command value that is smaller than the current speed command value is calculated as a new speed command value by Formula (1). For example, when the current fluctuation width is smaller than the target fluctuation width, a speed command value greater than the current speed command value is calculated as a new speed command value.

Subsequent to the fluctuation width feedback calculation of the speed command value in S930, a speed feedback control process of the output duty is performed in S940. Specifically, the output duty is calculated using the following Formula (2):

Output duty=(new speed command value−actual rotation number)Gb (2)

In Formula (2), the new speed command value is a new speed command value calculated in S930 (i.e., calculated by Formula (1)). However, if the present process proceeds to S940 because it is determined in S920 that an impact has not been detected, the currently set speed command value is used as the new speed command value. The actual rotation number is the current actual rotation number obtained in S820. Gb is a proportionality coefficient.

That is, the process in S940 is a speed feedback control process to calculate an output duty according to the difference between the new speed command value and the actual rotation number of the motor 4 such that the actual rotation number becomes equal to the rotation number (the target rotation number) indicated by the new speed command value.

Next, a description will be given of a case of calculating a duty ratio as the speed command value in the new value setting process in S830 with reference to FIG. 14. In the case of calculating a duty ratio as the speed command value, the CPU 41 executes the process in FIG. 14 as the new value setting process in S830.

In the new value setting process in FIG. 14, the respective processes in S1010 to S1030 are the same as the processes in S910 to S930 in FIG. 13. In S1030, however, the fluctuation width feedback control process using the above Formula (1) is performed with respect to the duty ratio as the speed command value.

After the fluctuation width feedback control process of the speed command value (duty ratio) is performed in S1030, of after it is determined in S1020 that an impact has not been detected, the present process proceeds to S1040. In S1040, it is determined whether the current output duty ratio (the current duty ratio) is equal to or greater than “a new speed command value—2%”.

If it is determined that the current duty ratio is equal to or greater than a value obtained by subtracting 2% from the new speed command value, the present process proceeds to S1050. In S1050, the output duty ratio is set to the new speed command value. As a result, if the current duty ratio is greater than the new speed command value by more than 2%, the output duty ratio is a value smaller than the current duty ratio.

If it is determined that the current duty ratio is smaller than a value obtained by subtracting 2% from the new speed command value in S1040, the present process proceeds to S1060. In S1060, the output duty ratio is set to a value obtained by adding 2% to the current duty ratio.

As described above, the fluctuation width feedback control of the speed command value is performed in the rechargeable impact driver 1 of the third embodiment. That is, corrective calculation of the speed command value is performed such that the fluctuation width of the rotation number during impacting will match the target fluctuation width. Accordingly, it is possible to enable application of an impact at an appropriate timing, and thus improvements in operability, operation efficiency, and operation results can be achieved.

### Other Embodiments

In terms of the detection timing of an impact, in the above described embodiments, occurrence or non-occurrence of an impact is detected at a timing when striking of the anvil 15 by the hammer 14 is expected in the process of periodic fluctuation of the rotation number and the current.

Specifically, in the case of detecting an impact based on the rotation number, each time a fluctuation of the rotation number from the minimum value to the maximum value is detected, occurrence or non-occurrence of an impact is detected based on the fluctuation width (the difference between the minimum value and the maximum value). Alternatively, in the case of detecting an impact based on the current, each time a fluctuation of the current value from the maximum value to the minimum value is detected, occurrence or non-occurrence of an impact is detected based on the fluctuation width (the difference between the maximum value and the minimum value).

However, the detection timing of an impact is not limited to the aforementioned timing. For example, each time a fluctuation width of the rotation number or the current is detected, occurrence or non-occurrence of an impact may be detected based on the fluctuation width. Specifically, in the case of detection based on the rotation number, for example, occurrence or non-occurrence of an impact may be detected, when the rotation number fluctuates from the maximum value to the minimum value, based on the fluctuation width, as well as when the rotation number fluctuates from the minimum value to the maximum value.

Alternatively, a determination may be made on occurrence or non-occurrence of an impact by comprehensively considering the fluctuation widths of a plurality of fluctuations that occur continuously (for example, based on an average value of the plurality of fluctuation widths).

(2) The determination process (determination of whether the fluctuation width is equal to or greater than the fluctuation width threshold value) in S260 in the workpiece discrimination process (FIG. 6) of the first embodiment is not limited to be performed based on the fluctuation width immediately preceding the time of detection of an impact. For example, the process in S260 (specifically the workpiece discrimination process to discriminate a workpiece based on the fluctuation width threshold value) may be performed using, in addition to (or instead of) the fluctuation width immediately preceding the time of detection of an impact, at least one fluctuation width detected further previously.

The same may be applied to each of the processes in S640, S660, S680 of the impact rotation angle discrimination process (FIG. 11) in the second embodiment and to each of the processes in S930, S1030 of the new value setting process (FIG. 13, FIG. 14) in the third embodiment.

(3) In the workpiece discrimination process (FIG. 6) of the first embodiment, discrimination of a workpiece based on the fluctuation width (S260 to S290) is performed when the number of detection of impacts after the start of application of an impact is equal to or less than ten. However, the number of ten is merely an example, and it may be appropriately defined within how many impacts after the start of application of an impact the discrimination of a workpiece should be performed. Alternatively, the discrimination of a workpiece may be performed continuously after the start of application of an impact regardless of the number of impacts.

(4) In the second embodiment, detection of an impact and calculation of the load shaft rotation angle during impacting are performed based on the fluctuation width of the current flowing in the motor 4. However, these may be performed based on the fluctuation width of the rotation number of the motor 4. In this case, the fluctuation width of the rotation number may be classified stepwisely into some levels and the counter values of the estimation counter K may be related to the respective levels in the similar manner as in FIG. 8A.

In third embodiment, in contrast, detection of an impact and the fluctuation width feedback control are performed based on the fluctuation width of the rotation number of the motor 4. However, these may be performed based on the fluctuation width of the current flowing in the motor 4.

Further, in any of the above described embodiments, various calculations or control processes based on the fluctuation width of the rotation number or the current of the motor 4 may be performed based on the fluctuation width of a physical quantity other than the rotation number and the current. The physical quantity other than the rotation number and the current may be any of various physical quantities that fluctuate due to an impact in the rechargeable impact driver 1.

It is preferable to employ a physical quantity that fluctuates periodically in synchronization with the cycle of application of an impact (at substantially the same cycle). Specific examples of the physical quantity include voltage applied to the motor 4, supplied power, the rotational position of the motor 4, and vibration and sound occurring in the rechargeable impact driver 1.

Also, fluctuation widths of a plurality of types of physical quantities may be employed. For example, the discrimination of a workpiece (the first embodiment), the calculation of the load shaft rotation angle (the second embodiment), or the fluctuation width feedback control (the third embodiment) may be performed by comprehensively considering the respective fluctuation widths of the rotation number and the current of the motor 4.

(5) In the third embodiment, the specific method of the feedback control is not limited to proportional control, and proportional-integral control (PI control), for example, may be employed. A control method other than proportional control and proportional-integral control may also be employed.

(6) In the above described embodiments, the description is given of an example in which the control circuit 31 comprises a microcomputer. However, the control circuit 31 may comprises, for example, an ASIC, an FPGA, other various ICs, a logic circuit, etc. instead of a microcomputer.

(7) In the above described embodiments, the motor 4 is a three-phase brushless motor. However, the present invention may be applicable to a rotary impact tool that is provided with a motor other than a three-phase brushless motor.

(8) In the above described embodiments, an example is shown in which the present invention is applied to the rechargeable impact driver 1. However, the present invention may be applicable not only to the rechargeable impact driver 1 but also to any type of rotary impact tool provided with an impact mechanism in which an impact action is caused by the rotational force of a motor.

(9) The present invention is not limited to any specific devices, structures, or the like that are shown in the above described embodiments. The present invention may be practiced in various manners within the scope not departing from the subject matter of the present invention. For example, some element in any of the above described embodiments may be replaced with a publicly-known element having a similar function, or may be added to or substituted for an element in any of the other embodiments, or may be omitted as long as the problems to be solved can be solved. Further, two or more of the above described embodiments may be appropriately combined.

What is claimed is:

1. A rotary impact tool comprising:
a motor;
an impact mechanism comprising:
a hammer configured to rotate by a rotational force of the motor;
an anvil configured to rotate by receiving a rotational force of the hammer; and
an attachment portion configured to attach a tool element to the anvil,
the impact mechanism being configured such that, when an external torque of a specified value or greater is applied to the anvil, the hammer leaves the anvil and rotates idly to impact the anvil in a rotational direction;
an impact detection unit configured to detect an impact to the anvil by the hammer;
a fluctuation width detection unit configured to detect, when an impact is detected by the impact detection unit, a fluctuation width of a physical quantity that fluctuates due to the impact; and
a control unit configured to control driving of the motor, the control unit controlling, when an impact is detected by the impact detection unit after a start of the driving of the motor, the driving of the motor according to the fluctuation width detected by the fluctuation width detection unit.

2. The rotary impact tool according to claim 1, wherein the physical quantity is a physical quantity that fluctuates at the same cycle as a cycle of occurrence of an impact.

3. The rotary impact tool according to claim 2, wherein the physical quantity is at least one of a rotation speed of the motor or a current flowing in the motor.

4. The rotary impact tool according to claim 1, wherein the control unit is configured to perform a driving force limiting control to reduce a rotation number of the motor and continue the driving of the motor or to stop the driving of the motor when the fluctuation width detected by the fluctuation width detection unit is equal to or greater than a fluctuation width threshold value.

5. The rotary impact tool according to claim 4, further comprising:
an operation unit configured to receive an operation input to drive the motor,
wherein the control unit is configured to perform the driving force limiting control by setting a speed command value of the motor according an operation amount of the operation unit, driving the motor based on the set speed command value, and, when the fluctuation width detected by the fluctuation width detection unit is equal to or greater than the fluctuation width threshold value, reducing the speed command value to less than a value according the operation amount or setting the speed command value to a value corresponding to stopping of the motor.

6. The rotary impact tool according to claim 4, wherein when an impact is detected by the impact detection unit, the control unit determines whether the fluctuation width is equal to or greater than the fluctuation width threshold value each time the fluctuation width is detected by the fluctuation width detection unit, cumulatively adds the number of determinations that the fluctuation width is equal to or greater than the fluctuation width threshold value, and performs the driving force limiting control when the number of cumulative additions is equal to or greater than a specified number.

7. The rotary impact tool according to claim 4, further comprising:
a rotational direction setting unit configured to set a rotational direction of the motor,
wherein the control unit is configured not to perform the driving force limiting control regardless of the fluctuation width when the rotational direction set by the rotational direction setting unit is a direction of removing a rotation object from a workpiece with the tool element.

8. The rotary impact tool according to claim 1, wherein the control unit is configured to calculate a total impact rotation angle, which is a rotation angle of the tool element after a start of application of an impact, based on the fluctuation width detected by the fluctuation width detection unit, and to control the motor according to the calculated total impact rotation angle.

9. The rotary impact tool according to claim 8, wherein the control unit is configured to perform, when the calculated total impact rotation angle is equal to or greater than a specified rotation angle, a driving force limiting control to reduce the rotation number of the motor and continue the driving of the motor or to stop the driving of the motor.

10. The rotary impact tool according to claim 9, further comprising:
an operation unit configured to receive an operation input to drive the motor,
wherein the control unit is configured to perform the driving force limiting control by setting a speed command value of the motor according to an operation amount of the operation unit, driving the motor based on the set speed command value, and, when the calculated total impact rotation angle is equal to or greater than the specified rotation angle, reducing the speed command value to less than a value according the operation amount or setting the speed command value to a value corresponding to stopping of the motor.

11. The rotary impact tool according to claim 8, wherein the control unit is configured to calculate the total impact rotation angle, when an impact is detected by the impact detection unit, by using, as a calculation target fluctuation width, at least one of a fluctuation width at the time of a change from a minimum value to a maximum value or a fluctuation width at the time of a change from a maximum value to a minimum value in a process of fluctuation of the physical quantity, and by cumulatively adding a unit impact rotation angle corresponding to the calculation target fluctuation width each time the calculation target fluctuation width is detected by the fluctuation width detection unit.

12. The rotary impact tool according to claim 1, wherein the control unit is configured to compare the fluctuation width detected by the fluctuation width detection unit and a preset target fluctuation width and to control driving of the motor such that the fluctuation width will match the preset target fluctuation width.

13. The rotary impact tool according to claim 12, further comprising:
an operation unit configured to receive an operation input to drive the motor,
wherein the control unit is configured to set a speed command value of the motor according an operation amount of the operation unit, to drive the motor based on the set speed command value, to correct the speed command value according the operation amount based on a difference between the fluctuation width detected by the fluctuation width detection unit and the preset target fluctuation width when an impact is detected by the impact detection unit, and to drive the motor according to the corrected speed command value.
